(19) United States
(12) Patent Application Publication
(10) Pub. No.: US 2002/0077795 A1
(43) Pub. Date: Jun. 20, 2002

(54) System, method and storage medium for predicting impact performance of thermoplastic

(76) Inventors: Joseph Thomas Woods, Chicopee, MA (US); Omar Hasan, Houston, TX (US)

Correspondence Address: CANTOR COLBURN, LLP, 55 GRIFFIN ROAD SOUTH, BLOOMFIELD, CT, 06002

(21) Appl. No.: 09/960,780

(22) Filed: Sep. 21, 2001

Related U.S. Application Data
(60) Provisional application No. 60/234,428, filed on Sep. 21, 2000.
(60) Provisional application No. 60/234,427, filed on Sep. 21, 2000.
(60) Provisional application No. 60/273,648, filed on Mar. 5, 2001.

(51) Int. Cl. G06G 7/48

(52) U.S. Cl. 703/6

(57) ABSTRACT

A method for predicting impact performance of an article constructed of a material includes: applying physical properties of the material to a constitutive model; performing at least one of uniaxial, biaxial, and triaxial property tests on samples of the material shaped according to test geometries; performing finite element simulation analysis on the test geometries using the constitutive model; determining failure criteria of the material using data from the uniaxial, biaxial, and triaxial property tests and the finite element simulation analysis on the test geometries; and applying the failure criteria and the constitutive model to finite element simulation analysis of the article.

### CROSS-REFERENCE TO RELATED APPLICATIONS

This application claims the benefit of U.S. provisional patent applications Ser. No. 60/234,428 filed Sep. 21, 2000, Ser. No. 60/234,427 filed Sep. 21, 2000 and Ser. No. 60/273,648 filed Mar. 5, 2001, the entire contents of which are incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright protection whatsoever.

### BACKGROUND

The disclosure relates generally to thermoplastic performance, and more specifically, to a method, system and storage medium for predicting impact performance of thermoplastic.

Accurately predicting the impact performance of thermoplastic parts is a challenge for engineers and designers. In order to correctly predict the total response of the material and part to an impact event, the engineer or designer must be able to predict the load-displacement response of the part prior to failure and the failure behavior. In order to accurately predict the load-displacement response of the material prior to failure, the engineer must know the elastic behavior, yielding behavior, and post yield behavior of the material. Next, predicting if failure will occur, along with the failure mode (e.g., ductile or brittle) and the load or displacement at failure, is more difficult. Nevertheless, this is necessary to determine whether a part will meet its impact specifications (typically described as energy absorption criteria). If the possible failure modes are not known, and if accurate failure criteria do not exist for each failure mode at the appropriate strain rate and temperature of the application, then the engineer cannot predict the energy absorption capability of the part. However, the current technique of determining impact performance by first manufacturing a part, and then testing the part, is wasteful, time-consuming and costly.

Finite element analysis (“FEA”) is useful for predicting the structural performance of plastic components. Through the use of finite element tools, conceptual designs may be assessed and mature designs may be optimized; thereby, shortening the costly build and test cycle. In the past, predictions were most useful in predicting the load-displacement response of the component. This was done by accurately modeling the geometry and boundary conditions, and by knowing the modulus of the material. However, as plastics are increasingly used in more demanding applications, such as load bearing automotive components, other nonlinear deformation processes and failure mechanisms become important. In plastics, the yield stress is typically strain rate sensitive and can be pressure dependent as well. Thus, to accurately predict these deformation mechanisms, a constitutive model is used, which accounts for them in a finite element analysis. Another consideration is the actual failure event (e.g., whether the material will behave ductiley or brittlely and under what condition will it behave ductiley or brittlely).

Tensile data may be used for generating material data for use in finite element simulation codes to predict impact performance. Using tensile data alone can reasonably approximate the deformation behavior of a material prior to failure. However, using tensile data alone is often not sufficient because of its limited value in predicting failure behavior. Such an approach is deficient for two reasons. First, a tensile specimen experiences a simple uniaxial state of stress. However, actual parts may experience uniaxial, biaxial or triaxial states of stress or, more likely, a combination of all three. The failure mode and failure criteria will depend upon the stress state. Materials which are ductile in a uniaxial, tensile, stress state may become brittle when exposed to a tensile, triaxial, stress state. The current practice used to predict impact performance relies on test data from simple uniaxial tensile tests. Thus, in the current practice, the effect of stress state and the potential for different failure criteria for different failure modes is ignored.

In addition, the value most typically used to predict failure, a true strain to failure number, is often not measured correctly. Often a percent elongation number is actually reported which is not a material property, but rather depends on the geometry of the tensile specimen. It is simply a measure of the total elongation of the specimen divided by its initial length. Attempts to measure a true strain number in a tensile test may be difficult, since most polymers neck and locally deform. The strain needs to be measured locally at the point of necking, which is unknown a priori in a standard ASTM or ISO tensile bar. In addition, even if the point of necking is known, standard extensometers are not refined enough to measure the local strain that occurs prior to failure. When a true strain to failure value is accurately determined using tensile data, it is time consuming and costly, and is usually done optically.

Nevertheless, the failure criterion currently used to predict whether or not failure will occur in an unfilled thermoplastic is typically a strain to failure value. Often, a percent elongation result or the equivalent is input into a finite element code. This is not correct, however, because a percent elongation does not represent a strain to failure value. The percent elongation is simply the ratio of the crosshead displacement at failure divided by the initial gauge length of the specimen. Since thermoplastic materials neck, the actual region of the specimen that is undergoing large deformations is smaller than the initial gage length. The displacement and accompanying strain is localized in the necked region.

In addition, finite element codes require a true strain value whereas a percent elongation is defined as an engineering strain value. To accurately obtain a true strain failure value in a tensile specimen is difficult, because of the necking and strain localization that occurs prior to failure. Optical extensometers are used at high displacement rates to overcome the difficulty of mounting and holding a mechanical extensometer in place at high strain rates. An optical extensometer by itself is not sufficient, however, because the strain recorded is still measured over a prescribed distance and not locally at the failure point. If the specimen is gridded and the deformation pattern recorded optically, reasonable values of true strain can be obtained at the failure point. Of course these tests are more time consuming and costly than traditional tensile tests.

### SUMMARY

The above described drawbacks and deficiencies of the prior art are overcome or alleviated by a method for predicting impact performance of an article constructed of a material. The method includes: applying physical properties of the material to a constitutive model; performing at least one of uniaxial, biaxial, and triaxial property tests on samples of the material shaped according to test geometries; performing finite element simulation analysis on the test geometries using the constitutive model; determining failure criteria of the material using data from the uniaxial, biaxial, and triaxial property tests and the finite element simulation analysis on the test geometries; and applying the failure criteria and the constitutive model to finite element simulation analysis of the article.

### BRIEF DESCRIPTION OF THE DRAWINGS

Referring now to the drawings wherein like elements are numbered alike in several FIGURES:

FIG. 1 is a block diagram of an exemplary system for predicting impact performance of thermoplastic;

FIG. 2 is a flow chart generally depicting a method for predicting impact performance of a thermoplastic;

FIG. 3 depicts an exemplary plot of a uniaxial stress-stretch curve for polycarbonate;

FIG. 4 depicts an exemplary plot comparing analytical load displacement responses for a barrier impact of an automotive bumper using the von Mises yield criterion versus a pressure-dependent yield criterion;

FIG. 5 depicts an exemplary plot showing yield stress of polycarbonate as a function of strain rate and temperature;

FIG. 6 depicts an exemplary plot of an elastic-perfectly plastic versus multilinear plasticity model;

FIG. 7 depicts exemplary test geometries for determining failure mode and criteria;

FIG. 8 depicts an exemplary three-point notched beam configuration;

FIG. 9 depicts an exemplary plot comparing analytical and experimental load-displacement traces from a disk;

FIG. 10 depicts an exemplary plot of an equivalent plastic strain contour for a disk specimen at failure;

FIG. 11 depicts an exemplary plot of an equivalent plastic failure strain versus strain rate for a polyetherimide (“PEI”) material at −30° C.;

FIG. 12 depicts an exemplary 3D finite element mesh used in three-point-bend notched beam analyses;

FIG. 13 depicts an exemplary plot comparing analytical and experimental load-displacement trace for a three-point-bend notched beam;

FIG. 14 depicts an exemplary comparison of maximum principal stress levels near the notch in a three-point-bend notched beam;

FIG. 15 depicts an exemplary plot of maximum principal stress for brittle failure as a function of strain rate for polyetherimide at room temperature;

FIG. 16 illustrates an exemplary method for obtaining parameters used in a deformation model;

FIG. 17 illustrates an exemplary method for determining failure criteria;

FIGS. 18A-D illustrate an implicit finite element material subroutine for the exemplary constitutive model for modeling deformation behavior of thermoplastics; and

FIGS. 19A-D illustrate an explicit finite element material subroutine for the exemplary constitutive model for modeling the deformation behavior and failure behavior of thermoplastics.

### DETAILED DESCRIPTION

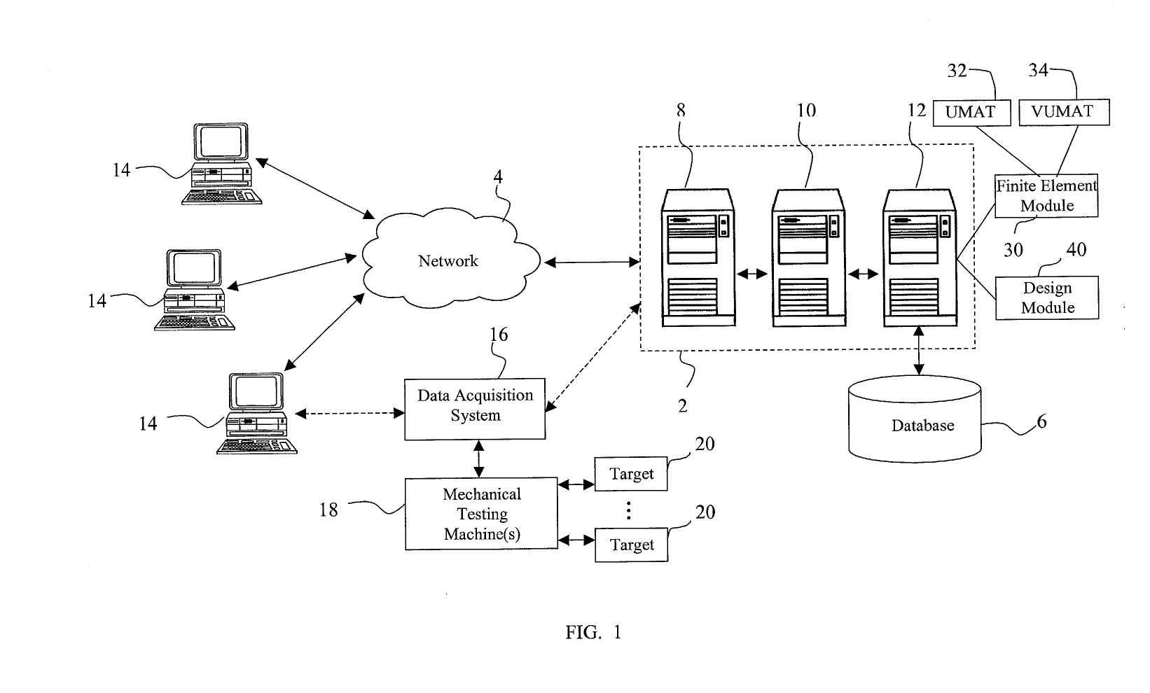

FIG. 1 is a block diagram of an exemplary system for predicting impact performance of thermoplastic in one embodiment. The system may include a host system 2, a network 4, one or more mechanical testing machines 18, one or more test fixtures with a target 20 and a data acquisition system 16 for use with the mechanical testing machines 18. One or more user systems 14 may be coupled to the host system 2 via the network 4. Each user system 14 may be implemented using a general-purpose computer executing a computer program for carrying out the process described herein. The network 4 may be any type of known network including a local area network (LAN), wide area network (WAN), global network (e.g., Internet), intranet, etc. Each user system 14 and the host system 2 may be connected to the network 4 in a wireless fashion and network 4 may be a wireless network. In another embodiment, the network 4 may be the Internet and each user system 14 may execute a user interface application (e.g., web browser) to contact the host system 2 through the network 4. Alternatively, the user system 14 may be implemented using a device programmed primarily for accessing network 4 such as WebTV.

The host system 2 may include one or more servers. In one embodiment, a network server 8 (often referred to as a web server) may communicate with the user systems 14. The network server 8 may be implemented using commercially available servers as are known in the art. The network server 8 handles sending and receiving information to and from user systems 14 and can perform associated tasks. The host system 2 may also include a firewall server 10 to: (a) prevent unauthorized access to the host system 2; and (b) with respect to individuals/companies that are authorized access to the host system 2, enforce any limitations on the authorized access. For instance, a system administrator typically may have access to the entire system and have authority to update portions of the system. By contrast, a user contacting the host system 2 from a user system 14 would have access to use applications provided by applications server 12 but not alter the applications or data stored in database 6. The firewall server 10 may be implemented using conventional hardware and/or software as is known in the art.

The host system 2 may include an applications server 12. Applications server 12 may execute a plurality of software applications or modules as shown in FIG. 1. The applications may include a finite element module 30 and a design module 40. The finite element module 30 may access a user-defined finite element material (UMAT) subroutine 32 and a vectorized (explicit) user-defined finite element material (VUMAT) subroutine 34, as will be described in further detail hereinafter. Each module and subroutine may serve as a tool that aids in predicting impact performance of thermoplastic as described herein. Note that each module may be implemented through a computer program. The computer program(s) that implement the modules may be stored on applications server 12 or may be stored in a location remote from applications server 12. Alternatively, more than one applications server may be used to execute the software applications or modules. The finite element analysis software is commercially available but, alternatively, may be user specified computer code. For example, finite element module 30 may that which is commercially available from Hibbit, Karlsson, & Sorensen, Inc. under the name ABAQUS.

The applications server 12 may be coupled to a database 6. Database 6 may contain a variety of information used by the software applications or modules. The database 6 may include data related to the development of a thermoplastic product, such as material specifications, material properties, constitutive model parameters, failure criteria, target 20 and part test results, and the like. The database 6 may also include design data, such as material comparison plots, finite element analysis data, finite element results, data comparing design iterations and the like. The database 6 may be an electronic database directly coupled to the applications server 12, or the database 6 may be in the form of separate electronic files, spreadsheet files, or the like. The data may also be stored on paper files and manually input into finite element analysis files.

One or more user systems 14 and/or the host system 2 may be coupled to the data acquisition system 16. The data acquisition system 16 may be used as part of, or in conjunction with, the mechanical testing machines 18 to record the load-displacement response of the target 20 being tested. The data acquisition system 16 may record data electronically into a computer file, or other recording means, such as a strip chart recorder may be used. Time may also be recorded so as to check the displacement rate at which the test is performed.

One or more mechanical testing machines 18 may be coupled to the data acquisition system 16 for testing one or more targets 20, such as a thermoplastic part or specimen. The mechanical testing machines 18 are used to perform material tests required to determine the deformation and failure behavior of the target 20 material, as will be discussed hereinafter. The mechanical testing machines 18 may be servohydraulic machines, but other types of machines can be used. The mechanical testing machines 18 may be used to perform tests at displacement rates that simulate the strain rate(s) of interest of the application or end use of the part. Also, the ability to test at various temperatures may be needed, unless the application of the target 20 is at room temperature only. Preferably, the testing is performed in an environmental chamber. Alternatively, the target 20 may be cooled or heated in a separate chamber to the temperature(s) of interest and then tested (preferably within about a minute) before a change in temperature. Test fixtures used for the target 20 may be used in conjunction with the mechanical testing machines 18 for performing various tests to determine characterization (e.g., tensile tests, compression tests, disk impact tests, notched beam tests and the like). As described later, one or more of these tests may be used to simulate three stress states that a part may experience in actual use: uniaxial, biaxial and triaxial.

In general, application server 12 is coded with a method for characterizing the aspects of material behavior into a set of material data and parameters needed to predict the impact performance of unreinforced, isotropic thermoplastic. A material transfer function (constitutive model) having five adjustable parameters that are determined via testing and data reduction techniques described herein is used in finite element analyses of the test parts to determine failure criteria. Note that the material transfer function simultaneously accounts for rate and pressure dependence, as well as ductile and brittle failure modes. Once the constitutive model parameters and the failure criteria are obtained, finite element analyses are performed by finite element module 30 to determine the performance of the part.

As discussed below, the constitutive model developed by the method described herein includes a deformation model and failure criteria. The deformation model characterizes how a material will behave prior to failure (e.g., how it will deform in response to applied loads). The failure criteria help to identify whether the failure will be ductile or brittle, and establishes ductile and brittle failure criteria. Further, the effects of strain rate and temperature upon the failure mode and failure criteria are determined. The effect of stress state on the failure behavior is also determined. As discussed later, three factors, stress state, strain rate and temperature, are considered when determining the failure behavior of a material.

Using the deformation model, the load-deflection response of the material can be accurately predicted prior to failure. The failure criteria map out possible failure modes of the material based on stress state, temperature and strain rates. Different failure criteria are developed for the different failure modes (e.g., ductile and brittle). Knowing the possible failure modes of a material, along with having accurate failure criteria for the different failure modes, the impact performance of the part may be accurately predicted.

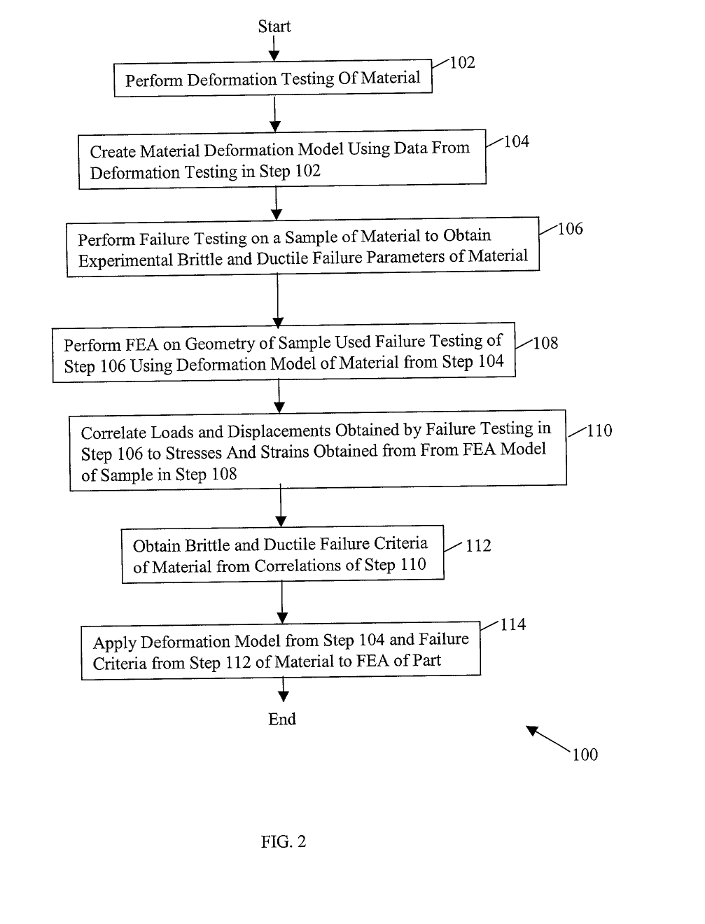

Referring to FIG. 2, a flowchart generally shows a method 100 employed by host system 2 of FIG. 1 for predicting impact performance of thermoplastic. Method 100 begins at step 102, where deformation testing of the material at target 20 is performed by mechanical testing machines 18. As will be described in further detail hereinafter, deformation testing may include tension and compression testing of the material at the service conditions of the part to be manufactured from the material. Method 100 continues to step 104 where a material deformation model is created using data from the deformation testing performed at step 102. Preferably, step 104 includes determining pressure dependent material parameters by comparing tensile and compressive yield stresses at the same rate for varying temperatures. After the deformation model is created in step 104, method 100 continues to step 106 where failure testing is performed by mechanical testing machines 18 on material samples using one or more of uniaxial, biaxial, and triaxial property tests at the service conditions of the part to be manufactured from the material. Method 100 then continues to step 108 where finite element analysis (PEA) is performed on the one or more test sample geometries from step 106 with the FEA model employing UMAT 32, which embodies the deformation model developed in step 104. In step 110, the loads and displacement values obtained by failure testing in step 106 are correlated with the stresses and strains obtained from the FEA model of the one or more sample geometries obtained in step 108. If more than one sample geometry is tested in step 106 and modeled in step 108, then the results from the various geometries are also correlated in step 110. From the correlations of step 110, brittle and ductile fracture criteria for the material are obtained in step 112. In step 114, the deformation model developed in step 104 and the failure criteria developed in step 112 are applied to FEA of the part to be manufactured to predict the impact performance of the material in the article. Preferably, the deformation model and failure criteria are embodied in VUMAT 34, which can be accessed by the FEA model.

The general method 100 will now be discussed in further detail in the following sections I through IV. Section I provides general information for the characterization of the deformation model, as applied in steps 102 and 104 of method 100. Section II provides a preferred embodiment for characterization of the deformation model, as applied in steps 102 and 014 of method 100. Section In provides a preferred embodiment for characterization of the failure criteria, as applied in steps 106-112 of method 100. Section IV provides a preferred embodiment for the application of the deformation model and failure criteria of the material in a finite element analysis to predict part failure, as applied in step 114 of method 100.

I. Deformation Model Characterization

In determining the deformation behavior of a material, three areas may be considered; the elastic response, the yield response, and the post yield response.

Elasticity

For thermoplastics, characterizing the elastic response of the material for use in finite element codes may be obtained through standard ASTM or ISO 9000 test procedures on tensile bars. Usually an elastic modulus and Poisson's ratio is all that is needed. Poisson ratios for most thermoplastic resins range between about 0.35 and about 0.4. The elastic modulus is typically not very rate sensitive, although at slow strain rates, somewhat lower modulus values may be obtained because of viscoelastic effects. Modulus is somewhat temperature dependent and, therefore, may be tested at the application temperature(s).

Standard elastic-plastic stress-strain models in commercial finite element codes assume a linear elastic response prior to yielding. In actuality polymers exhibit a nonlinear elastic response prior to the plateau in their stress-strain curve. If the yielded region of the part is small, this nonlinear elastic response prior to yield can typically be ignored without having a noticeable affect on the global load-deflection prediction. If the yielded region is significant such as in simulating a dynatup puncture test, including this nonlinear elastic response may result in even more accurate predictions. This behavior is most often implemented in a user defined material subroutine.

Hyperelastic material models are available in some commercial finite elements codes which allow for nonlinear elastic material behavior up to very large strains. However these models are intended for rubber like or elastomeric materials. These materials are essentially incompressible, do not yield, and can experience elongation of several hundred percent.

Yielding

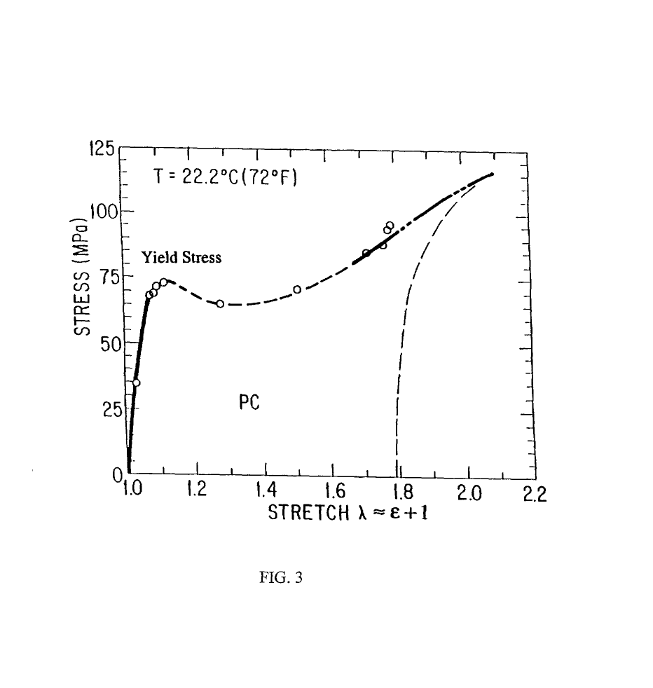

Yielding is typically defined using a simple tensile test. In plastic finite element simulations, the yield stress is usually taken to be the initial peak in a uniaxial stress-strain curve (see FIG. 3). Even though this yield stress limit is associated with a uniaxial stress field, effective stress expressions are available to define yielding for multiaxial stress fields as well. Yield predictions can then be made by comparing an effective, multiaxial stress, usually the von Mises stress, given in equation (1), with the uniaxial yield stress of the material. Yield occurs when the effective, von Mises stress equals the uniaxial, tensile yield stress. Although the von Mises yield criterion originated for metals, it has been used successfully to predict load-deflection behavior in thermoplastic parts experiencing yielding.

$${σ}_{mises} = \frac{1}{\sqrt{2}} \sqrt{{( {σ}_{1} - {σ}_{2} )}^{2} + {( {σ}_{2} - {σ}_{3} )}^{2} + {( {σ}_{1} - {σ}_{3} )}^{2}} = {σ}_{y} \qquad ( 1 )$$

where:

σₘᵢₛₑₛ is the von Mises yield stress

σ_{y} is the uniaxial yield stress

σ₁, σ₂ and σ₃ are the principal stresses

Pressure effects upon yielding

As a consequence of using the von Mises criterion, yielding is assumed to be independent of hydrostatic stress or pressure defined in equation (2):

$${σ}_{h} = \frac{{σ}_{1} + {σ}_{2} + {σ}_{3}}{3} \qquad ( 2 )$$

where:

σₕ is the hydrostatic stress

σ₁, σ₂ and σ₃ are the principal stresses

However, many thermoplastics do display pressure-dependent yielding behavior. Tensile hydrostatic stresses tend to decrease the yield stress, while compressive hydrostatic stresses tend to increase the yield stress. Note that the hydrostatic pressure is equal in magnitude to the hydrostatic stress but opposite in sign, (e.g., multiplying the hydrostatic stress by negative one gives the hydrostatic pressure).

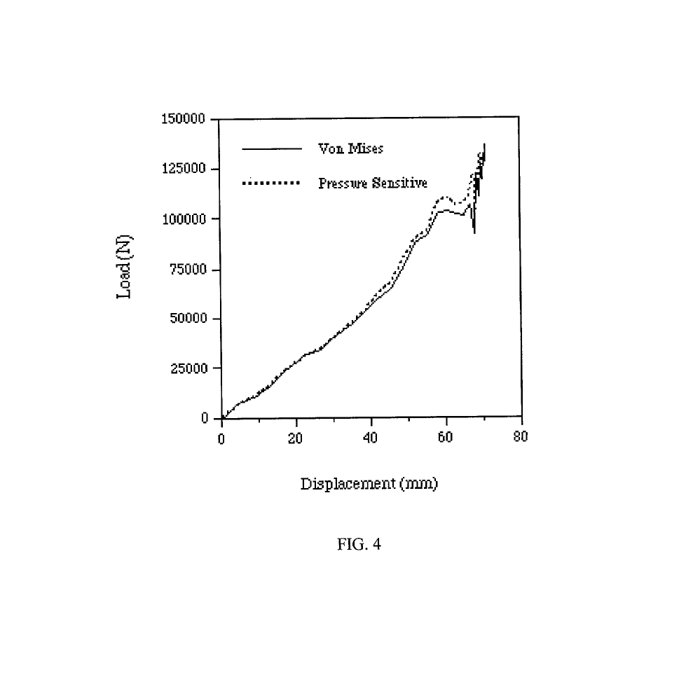

In most cases, pressure effects on yielding are not significant from an engineering viewpoint and may be ignored. Since most thermoplastic parts are thin walled, large hydrostatic stress fields cannot develop, except possibly near some local stress concentrations. Therefore, ignoring pressure effects will not significantly affect gross part performance predictions. For example, a comparison of load-deflection behavior for a barrier impact of an automotive bumper using a von Mises yield criterion versus using a pressure-dependent yield criterion is shown in FIG. 4. Note that little difference is observed when a pressure-dependence parameter characteristic of a Polycarbonate/Polyester blend is used.

For materials with a large rubber content, pressure effects on yielding are more significant. For these materials, cavitation of the rubber occurs under tensile stress fields resulting in a lower tensile yield stress. In a standard tensile test these materials typically experience large extensions (e.g., greater than about 50%) with little or no lateral contraction because of the “additional volume” created by the cavitation of the rubber. Under compressive stress fields the rubber does not cavitate resulting in a larger compressive yield stress. If a material's yield stress is significantly pressure dependent, and if a part sees large regions of compressive stress, then using a pressure dependent yielding model (or a separate tensile and compressive yield stress) in a finite element analysis would yield better part performance predictions. A comparison of the tensile and compressive yield stress of a variety of polymers at room temperature is shown in Table 1.

TABLE 1

| | Tension | Compression | |
|---|---|---|---|
| Material | (mega Pascals) | (mega Pascals) | Ratio |
| Acrylonitrile-butadiene-styrene | 42.5 | 45.9 | 1.08 |
| Polycarbonate/Acrylonitrile- | 56.0 | 62.0 | 1.11 |
| butadiene-styrene | | | |
| Polycarbonate | 66.0 | 66.0 | 1.00 |
| NORYL ® GTX910 | 55.0 | 76.0 | 1.38 |
| NORYL ® EM6100 | 36.0 | 60.0 | 1.67 |
| Polybutylene terephthalate | 53.1 | 73.1 | 1.38 |
| Polycarbonate/Polyester | 51.0 | 61.0 | 1.19 |

Strain Rate and Temperature Effects Upon Yielding

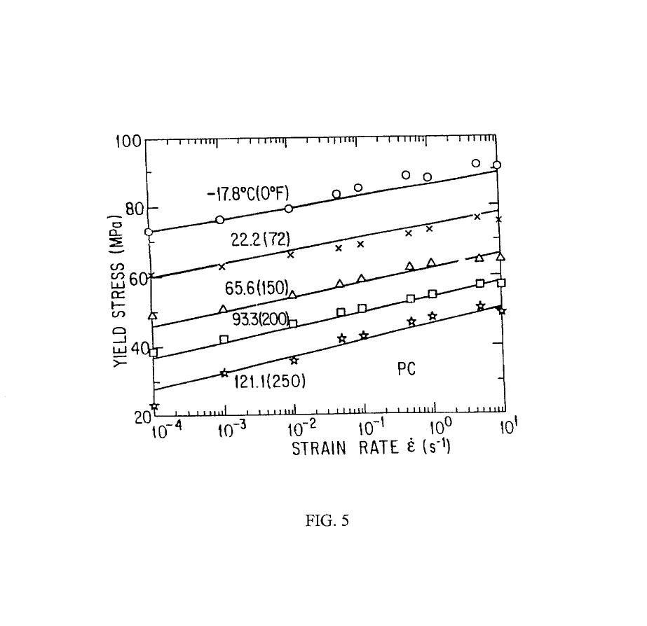

The yield stress of a polymer depends upon the rate and temperature at which it is tested. In general, higher rates and lower temperatures lead to higher yield stresses. Examples of temperature and rate effects on the yield stress of polycarbonate are shown in FIG. 5. As shown, the yield stress increases linearly for each order-of-magnitude increase in strain rate.

Material Characterization and Modeling for Yielding

When yielding is included in a numerical simulation, yield data at the appropriate temperatures and strain rates is used. The temperature experienced by the part is usually known. However, the strain rate experienced by the part is calculated. The strain rate may be approximated by dividing the maximum strain found in the part at a given displacement by the time it took the part to reach that displacement. If the part geometry and loading is simple enough, the strain may be calculated using closed-form solutions. For more complex geometries and loadings, or for more accurate results, an elastic finite-element analysis may be performed to calculate the strains in the part for a given deflection.

Once the temperature and strain rates of the part are known, tensile testing may be performed under these conditions to determine the temperature and rate dependence of the yield stress. Note that an application is usually at a uniform temperature when being impacted, therefore simulations may be performed without a temperature dependent yielding model (provided the material has been tested at the application temperature). For example, if an application must meet certain energy requirements at room temperature and −30° C., then tensile testing may be performed at each temperature (with the appropriate data being used to simulate performance under each temperature). Estimating the strain rate in a component is more difficult. In addition, the strain rate in the part will vary from location to location.

In certain finite element analyses that account for dynamic effects, strain rates are calculated internally and a rate-dependent yielding model may be defined. This approach eliminates the need for performing an initial elastic finite element analysis to estimate strain rate and allows the yield stress to vary throughout the part based on local strain rates. If a rate dependent plasticity model is used, testing may be performed over a range of strain rates and a rate dependent plasticity model fit to the data. For most polymers, yield stress varies linearly versus the log of strain rate. Preferably, yield stress values are measured over a few decades of strain rate and cover the range of strain rates encountered in the application.

If a rate dependent yielding model is not going to be used, the strain rate experienced by the part is estimated. Since yielding will occur first in the most highly strained region, it is recommended that the strain rate be calculated for the region of highest strain. Since the effect of rate on yield stress is only significant for orders-of-magnitude variations in rate, approximating the yield stress using the maximum strain rate in the part is usually sufficient. If the strain rate is beyond testing limits, the yield stress may be tested over a few orders of magnitude of strain rate. A linear fit of yield stress versus log strain rate can be used to extrapolate the yield stress out to the higher strain rate.

Post Yield Behavior

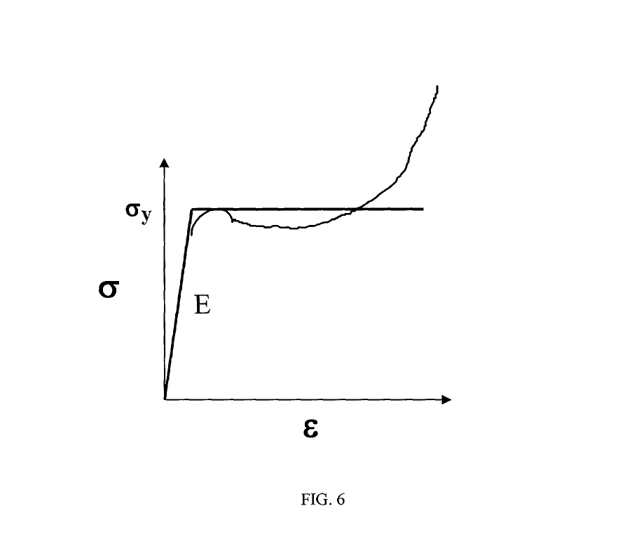

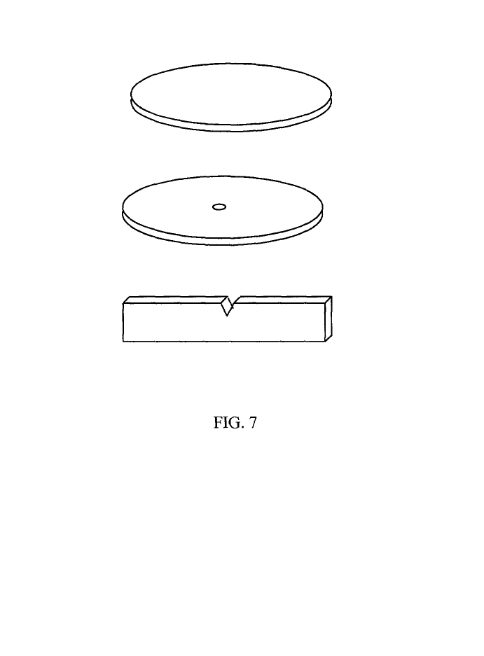

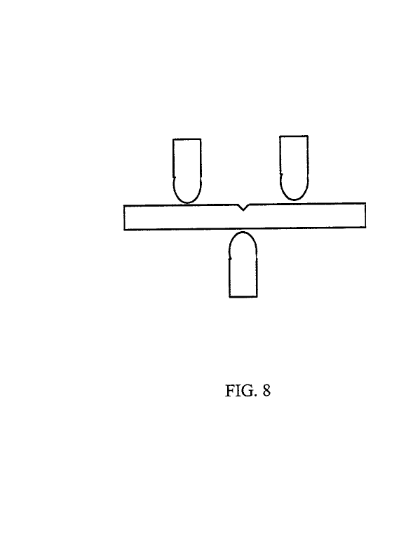

For many polymers, a decrease in stress is seen immediately after yield followed by a subsequent increase in stress (see FIG. 3). These post yield behaviors are referred to as strain softening and strain hardening, respectively. This hardening behavior is caused by molecular chain alignment. Post yield behavior may be important for predicting the performance of structures experiencing areas of high strain. For many thermoplastics, strain hardening occurs for strains beyond about 40%. If strains are expected to be below about 40%, the simplest model to use in a finite element analysis is an elastic-perfectly plastic model. In this model, an elastic modulus and yield stress are entered. The stress-strain curve is assumed to remain flat following yield, e.g., perfectly plastic (see FIG. 6). For strain levels larger than about 40%, most polymers begin to display strain hardening behavior. In such a case, a multilinear plasticity model (accounting for strain softening, and more importantly for strain hardening behavior) will provide more accurate results.

Material Characterization for Post Yield Behavior

To determine the yield stress of the material, it is sufficient to perform a standard tensile test and measure the engineering stress-strain response (which is based on the initial cross sectional area and gage length of the specimen) as shown in equations (3) and (4). This results in a stress-strain curve that rises to reach a peak and gradually decrease.

| | | | |
|---|---|---|---|
| σ | = F/A₀ | (3) | engineering stress |
| ε | = (1 − 1₀)/1₀ | (4) | engineering strain |

where:

σ is the engineering stress

ε is the engineering strain

F is the load on the specimen

Aₒ is the initial cross sectional area

lₒ is the initial gage length

l is the current gage length

If the post yield behavior of the material is desired, then a true stress-strain curve is used. A true stress-strain curve is more difficult to obtain since the stress is based on the current cross sectional area, and not the initial cross sectional area. Once necking initiates, the cross sectional area changes quickly, resulting in an initial load drop. Then the material starts to harden and the neck propagates, resulting in a increase in the true stress response, (e.g., strain hardening). True stress and strain equations are shown in equations (5) and (6).

| | | | |
|---|---|---|---|
| σₜ | = F/Aᵢ | (5) | true stress |
| εₜ | = 1n (1/1₀) | (6) | true strain |

where:

σₜ is the true stress

εₜ is the true strain

F is the load on the specimen

Aᵢ is the instantaneous cross sectional area

lₒ is the initial gage length

l is the current gage length

Two general measurement techniques may be used for measuring the true stress-strain response. One option is to grid the specimen and optically record the deformation while recording the load, as is known in the prior art. The deformation measurements may be made in the necked region. This technique is accurate, although tedious. Another technique is to perform compression testing on cylindrical specimens. In a compression test the measurement difficulties associated with necking are eliminated since the specimen diameter expands uniformly. Once plasticity occurs, the material behaves incompressibly, e.g., it is volume preserving. If volume is preserved, relationships relating true stress and strain to engineering stress and strain are obtained (see equations (7) and (8)). Compressive engineering stress-strain data may be recorded and converted to true-stress stain data through equations (7) and (8).

| | | | |
|---|---|---|---|
| σₜ | = σ(1 + ε) | (7) | true stress to engineering stress |
| εₜ | = 1n (1 + ε) | (8) | true strain to engineering strain |

where:

σₜ is the true stress

εₜ is the true strain

σ is the engineering stress

ε is the engineering strain

When performing a compression test, some practical considerations are noted. First, certain specimen dimensions may be important: specifically the ratio of the height of the specimen to the diameter of the specimen. If the height to diameter ratio is too large, buckling may occur. If the height to diameter ratio is too small barreling may occur. Barreling refers to the specimen taking a “barrel” shape, e.g., its sides bulge out at the center. Barreling is caused by frictional forces restraining the lateral growth of the specimen where it contacts the platen. This may result in a non-uniform cross section as well as “dead” conical zones adjacent to the platens where no deformation occurs causing erroneous stress-strain data. Barreling may be minimized by reducing friction between the specimen and the platen through lubricant sprays or sheets. To minimize barreling without buckling, a length to diameter ratio of about 1.5 to about 2.0 is recommended. In addition, compression tests may be performed at low strain rates to avoid heating the specimen (which would soften the stress-strain response). Note that strain rates on the order of 1×10⁻⁴ to 1×10⁻³ 1/s may be tested without specimen heating.

Although using compression data to estimate the post yield behavior of the material may need to include practical considerations, the test may be much simpler to perform than the optical tensile technique. Therefore, if the rate dependence of the hardening is deemed important, then the optical technique may be preferred. On the other hand, if speed and costs are more important, then the compression test may be preferred.

If the pressure dependence of the yield stress is desired, then tension and compression tests may be performed. The pressure dependent yielding parameter can be calculated by using tensile and compressive yield stress values at the same strain rate. The exact calculation of the pressure dependent yielding parameter will depend on the pressure dependent model employed.

II. Preferred Method of Deformation Model Characterization

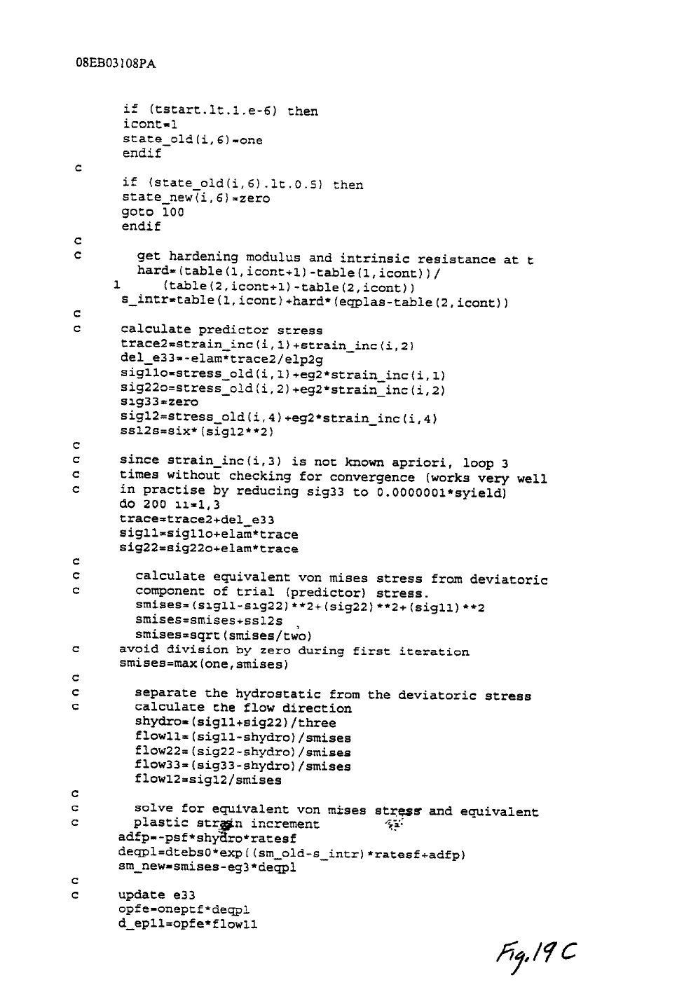

This section provides a preferred method of deformation model characterization, as applied in steps 102 and 104 of method 100. The following embodiment includes a preferred technique, along with alternative techniques. This constitutive model may be in the form of computer code and implemented as a user defined material subroutine for use with standard finite element codes, as shown in FIG. 1 as UMAT 32 and as provided in FIG. 18.

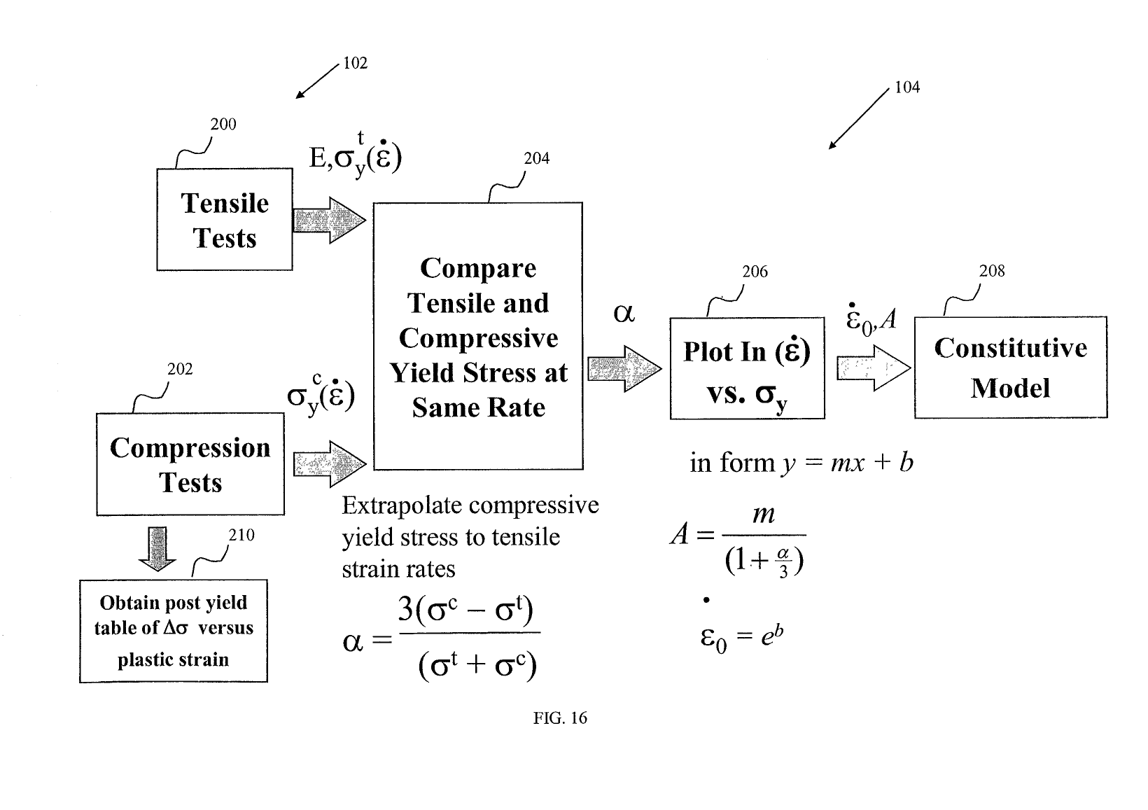

To characterize the deformation behavior of a material, tension and compression tests may be performed at the temperatures of interest (steps 200 and 202 of FIG. 16). Tensile tests (step 200) may be performed on standard ASTM or ISO bars at three to four displacement rates covering three to four orders of magnitude in displacement rate. Typically, specimens may be tested at 0.02, 0.2, 2.0, and 20 in/s. Tests may be performed at higher strain rates if desired. Displacement rates are chosen to cover the range of strain rates that may be seen in the application utilizing the material. Compression tests may be performed on cylindrical specimens, with a height to diameter ratio between 1 to 1 and 2 to 1. Typically, specimens of about 0.635 centimeter (0.25 inch) high by about 0.635 centimeter (0.25 inch) in diameter may be tested. Note that if the height to diameter ratio is too large (e.g., greater than about 2 to 1), buckling of the specimen may occur. On the other hand, if the height to diameter ratio is too small (e.g., less than about 1 to 1), barreling may occur. Note that barreling refers to the specimen taking a “barrel” shape. Barreling is caused by frictional forces restraining the lateral growth of the specimen where it contacts the platen. This results in a nonuniform cross section as well as “dead” conical zones adjacent to the platens where no deformation occurs, thus, causing erroneous stress-strain data. Teflon® coating may be applied between the top and bottom surfaces of the compression specimens and the platen surfaces to reduce friction between the two surfaces and minimize barreling. Compression specimens may be tested at slow rates to avoid heating of the specimens during testing. To avoid heating, strain rates on the order of 0.0001 and 0.001 1/s may be used for the compression tests. In addition, for low temperature tests, tensile and compression specimens may be tested in an environmental chamber and allowed to equilibrate in the chamber for at least one hour prior to testing.

Tensile tests may be performed for two primary purposes, to determine the elastic modulus of the material and to determine the strain rate dependence of the yield stress. Tensile tests may be performed in accordance to ASTM D638. Appropriate ISO 9000 standards may be substituted. Elastic moduli may be recorded in accordance with these standards. A Poisson ratio of 0.4 may be assumed for most thermoplastics, with typical values ranging between 0.35 and 0.42. Note that the load deflection response of the material is not sensitive to this parameter, but it may be tested for if desired. For each displacement rate tested the yield stress may be recorded, with the yield stress taken as the initial peak in the engineering stress-strain curve. Next, yield stress may be plotted versus the natural log of strain rate. Typically, the yield stress varies linearly versus the log of strain rate for most thermoplastics. A linear regression of the natural log of strain rate versus yield stress may be obtained to characterize the rate dependence of the yield stress.

After yielding, most thermoplastics display strain-hardening behavior, which may be preceded by some initial strain-softening behavior. This behavior is not characterized by a traditional tensile engineering stress-strain curve, which will flatten out and drop after yielding (since the change in the cross sectional area at the necked region is not accounted for). In order to characterize the post yield behavior, a true stress-strain curve is used. A true stress-strain curve is more difficult to obtain in tension since the stress is based on the current cross sectional area and not the initial cross sectional area. Once necking initiates, the cross sectional area changes quickly resulting in an initial load drop. Then the material starts to harden and the neck propagates, resulting in an increase in the true stress response, e.g., strain hardening. Thus, a compression test may be preferred as an alternative to performing tensile tests to obtaining post yield true stress-strain behavior. From a practical viewpoint, the compression test is a simpler test to perform, requires less specialized equipment (such as optical measurement devices), and is quicker and less costly.

A compression test at each temperature of interest may be performed to characterize the true stress-strain, post yield, behavior of the material. Preferably, about 5 specimens at each temperatures of interest may be tested (to account for variation). Since necking does not occur in compression, a near uniform expansion in cross sectional diameter can be obtained if barreling is minimized. Note that barreling can be minimized by keeping a specimen height to diameter ratio about 2 to 1 and by reducing friction between the top and bottom surfaces of the specimen and the test platen. The change in diameter can be accurately predicted by assuming incompressible material behavior after necking, e.g., a Poisson's ratio of 0.5. Assuming incompressibility, e.g., the material is volume preserving, true stress and true strain values can be calculated by knowing the corresponding engineering stress strain values through equations (7) and (8) as previously described.

When using compression data to estimate the post yield behavior, there are factors that need to be accounted for. First, the compressive and tensile yield stresses may be different at the same strain rate. Second, the compressive test may need to be performed at a much slower strain rate than the part will experience. Given these circumstances, one technique is to use the tensile yield stress at the appropriate strain rate and superimpose the post yield behavior. This may be done by making a table of Δσ versus strain by picking off stress-strain points from the compression stress-strain curve and subtracting off the compressive yield stress. To calculate the total stress to be entered into the finite element code, add the Δσ value from the table to the rate and temperature dependent tensile yield stress, as shown in equation (9). Note that when using this technique, it is assumed that the post yield behavior is not rate dependent.

σₜₒₜₐₗ=σ(\dot{ε},T)_{yield}+Δσ (9)

where:

σₜₒₜₐₗ is the true total stress

σ\dot{ε},T)_{yield} is the strain rate, \dot{ε}, and temperature, T, dependent tensile yield stress

Δσ is the total stress in compression minus the compressive yield stress

Post yield, true stress-strain curves can also be generated using tensile specimens, if the specimen is gridded and the deformation is recorded optically so that the change in cross sectional area at the neck can be accurately measured. Since these measurements are difficult, the necked region may be cut from the sample and the test continued for the propagated-necked region to determine hardening behavior. However, the optical approach may be more difficult and time consuming, and possibly less accurate than compression tests.

A compression test may also be performed to determine the pressure dependence of the yield stress at each temperature of interest. Unlike metals, most thermoplastics display some pressure dependent material behavior. Yielding is not independent of the hydrostatic stress or pressure as is assumed when a standard von Mises yield criterion is utilized. Tensile hydrostatic stresses tend to decrease the yield stress, while compressive hydrostatic stresses tend to increase the yield stress. For thermoplastic materials with a large rubber content, pressure effects on yielding are more significant. For such materials, cavitation of the rubber occurs under tensile stress fields resulting in a lower tensile yield stress. Under compressive stress fields, the rubber does not cavitate resulting in a larger compressive yield stress. By determining the tensile and compressive yield stresses at the same strain rate, a pressure dependent material parameter may be calculated and utilized in the constitutive model that may be represented by a user defined, finite element material subroutine (UMAT 32 of FIG. 1). An example of a user defined finite element material subroutine is provided in FIGS. 18A-D.

The Constitutive Model

As previously mentioned, the constitutive model described herein accounts for both rate and pressure dependent plastiticity. Post yield strain softening and strain hardening are also accounted for. The constitutive model is shown in equation (10):

\overline{ε}ₚₗ=\dot{ε}ₒexp[A(T){σ−S(\overline{ε}ₚₗ) }]×exp[−pαA(T)] (10)

where:

\overline{ε}ₚₗ is the equivalent plastic strain rate

\overline{ε}ₚₗ is the equivalent plastic strain

A, \dot{ε}ₒ are rate dependent yield stress parameters which depend on temperature (T)

(note that A and \dot{ε}ₒ are described in step 204 below)

σ is the equivalent von Mises stress

S is internal resistance stress (post yield behavior)

α is pressure dependent yield stress parameter

A standard isotropic elasticity model is employed to model elastic behavior prior to yield. The elastic parameters input into the model include an Elastic modulus and a Poisson's ratio.

Note that five material parameters are needed for use with the constitutive model as well as a post yield stress-strain table. These 5 material parameters are constants for a given material. Each material would have a unique set of constants for a given temperature. When these constants are used in the constitutive model, which is a mathematical representation of material stress-strain behavior, the stress-strain behavior of the material can be predicted which would enable one to predict the load-deflection response of a part, the stiffness of a part, when yielding will occur in a part, and stresses and strains in a part. The post yield stress-strain table describes the true stress-strain behavior of the material after yielding has initiated. Each material would have a unique post yield stress-strain table for a given temperature.

The five parameters are shown below:

E is the elastic modulus

υ is the Poisson's ratio

A, \dot{ε}ₒ are rate dependent yield stress parameters which depend on temperature (T)

α is the pressure dependent yield stress parameter

Referring to FIG. 16, an embodiment of steps 102 and 104 of method 100 is shown in further detail. FIG. 16 is an exemplary embodiment for obtaining the five parameters used in the constitutive model as well as the post yield true stress-strain table will now be described.

In step 200, tensile tests may be performed at a temperature of interest over a range of rates. Tests must be performed at a minimum of two strain rates. Three or more strain rates are preferred for accuracy covering three or more decades of strain rates. Note that it may be preferable to choose strain rates that match strain rates typically seen in the application utilizing a particular thermoplastic part. Thus, about three to five replicates may be tested at each rate and temperature combination (to account for variation). Load displacement data may be collected and converted to stress strain data using standard ASTM or ISO9000 procedures. An elastic modulus, E, and Poisson's ratio, υ, may also be calculated using standard ASTM or ISO 9000 procedures. The yield stress is recorded for each strain rate tested, with the yield stress taken as the initial peak in the engineering stress-strain curve. Next, a plot of the natural log of strain rate vs. yield stress may be generated for each temperature of interest. The natural log of strain rate may be plotted on the y-axis and yield stress plotted on the x-axis. Typically, the yield stress varies linearly versus the log of strain rate for most thermoplastics. A linear regression of the natural log of strain rate versus yield stress is obtained and the slope, m, and y-intercept, b, of the plot is recorded and/or saved.

In step 202, compression tests may be performed at a temperature of interest. Preferably a single slow strain rate on the order of about 0.0001 to 0.001 1/s may be chosen to help avoid material heat up during the test. Note that the technique for performing the compression test was previously described. Preferably, five replicates may be performed at each rate (again, to account for variation). Load displacement data is collected and converted to true stress-strain curves using the procedure previously described. For each temperature tested, the initial peak in the true stress-strain curve is recorded and/or saved as the compressive tensile yield stress.

In step 204, the pressure dependent yield stress parameter, α, is calculated by comparing the compressive and tensile yield stress values at the same strain rate. Typically, the compressive yield stress value at the low strain rate is extrapolated to the faster strain rate value of the tensile yield stress tests by using the slope, m, of the natural log strain rate versus tensile yield stress plot (as previously mentioned in the tensile testing description). The pressure dependent yield stress parameter, α, may be calculated using equation (11) shown below:

$$α = \frac{3 ( {σ}_{y}^{c} - {σ}_{y}^{t} )}{( {σ}_{y}^{t} + {σ}_{y}^{c} )} \qquad ( 11 )$$

where:

α is the pressure dependent yield stress parameter

σ_{y}^{c} is the compressive yield stress

σ_{y}^{t} is the tensile yield stress

In step 206, the two parameters, \dot{ε}ₒ and A, which determine the rate dependence of the yield stress, may be calculated knowing α and the slope, m, and y-intercept, b, of the natural log of strain rate versus tensile yield stress graph (as previously described).

$$A = \frac{m}{( 1 + \frac{α}{3} )}$$

$${\dot{ϵ}}_{0} = {e}^{b}$$

where:

A, \dot{ε}ₒ are rate dependent yield stress parameters which depend on temperature (T)

m is the slope of the natural log strain rate versus tensile yield stress plot

b is the y-intercept of the natural log strain rate versus tensile yield stress plot

α is the pressure dependent yield stress parameter

e is the base of the natural log; e=2.71828

Having the 5 material parameters for the constitutive model, E, □, □, \dot{ε}ₒ and A, the final data to be determined is the post yield behavior.

In step 210 the post yield stress-strain table is obtained from the compression data. The post yield behavior is obtained from the true stress-strain compression data previously obtained. A table of Δσ versus plastic strain is generated by selecting stress-strain points from the compression stress-strain curve. Points are selecting starting at the initial peak in the stress strain curve, which corresponds to the compressive yield stress. A minimum of three points is required to define the post yield behavior; the yield point, the point where strain hardening begins and the end point of the test. More data pairs are recommended to better represent the shape of the stress-strain curve. Usually 8-10 points are selected are roughly evenly spaced intervals of strain of approximately 0.1 in/in. More or fewer points could be chosen. The Δσ value for the table is calculated by subtracting off the compressive yield stress using equation (12) shown below from the true total stress value:

Δσ=σₜₒₜₐₗ−σ_{y}^{c}(T) (12)

where:

σₜₒₜₐₗ is the true total stress

σ_{y}^{c}(T) is the compressive yield stress at the temperature of interest

Δσ is the total stress in compression minus the compressive yield stress

The Δσ versus plastic strain table is then input into the user defined finite element subroutine along with the five constitutive model parameters. As previously noted, an exemplary embodiment of the user defined finite element material subroutine is provided in FIGS. 18A-D. Thus, in step 208, the constitutive model is completely defined.

III. Failure Criteria Characterization

When assessing impact performance, failure is a concern. Most impacted thermoplastic parts are specified to absorb certain impact energy without failing. Automotive bumper impacts and impacts of electronic enclosures dropped from height are good examples. Furthermore, two different failure modes are possible: ductile and brittle.

In a ductile failure, the part fails in a slow, noncatastrophic manner in which additional energy is required to further spread the damage zone. In contrast, a brittle failure is characterized by a sudden and complete failure that, once initiated, requires no further energy to propagate. Note that the failure criteria for the two failure modes differ. Generally, effective stress (von Mises stress) is used to assess when plastic (permanent) deformation has initiated. If some permanent deformation is acceptable, then a strain-to-failure criterion may be used as the ductile failure criterion indicating when tearing is expected to occur. For a brittle failure criterion, maximum principal stress may be used to assess failure and predict part performance.

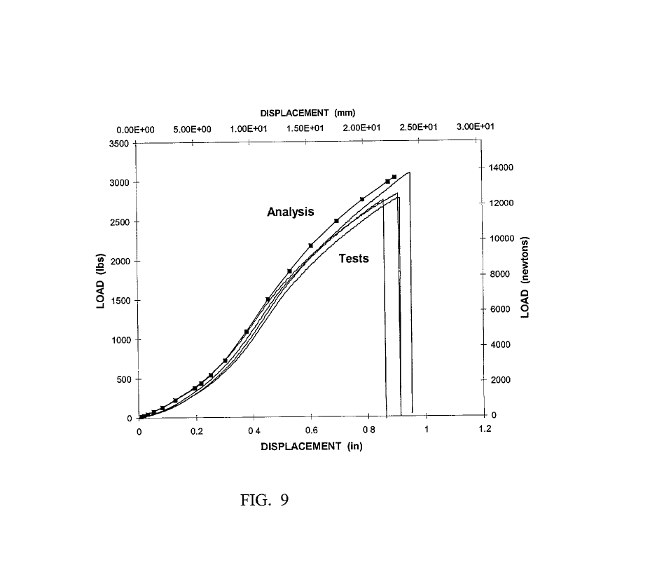

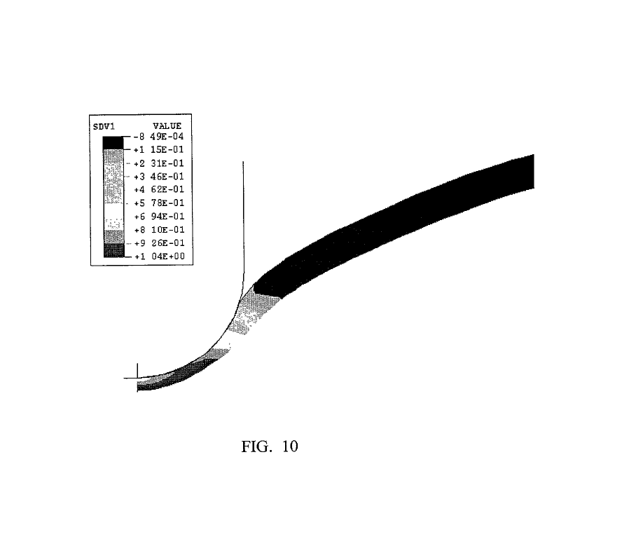

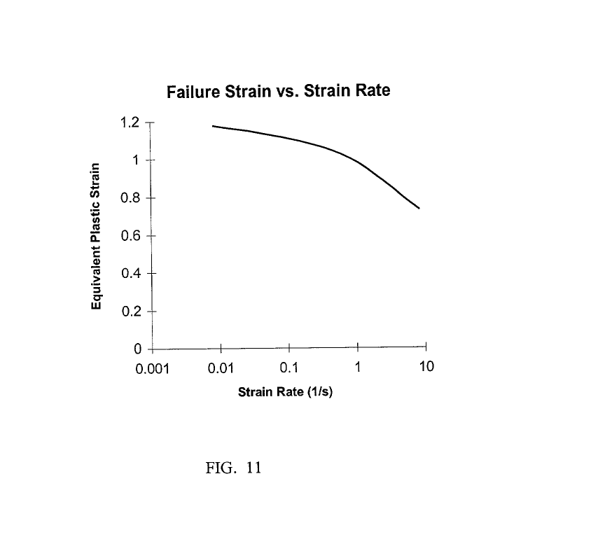

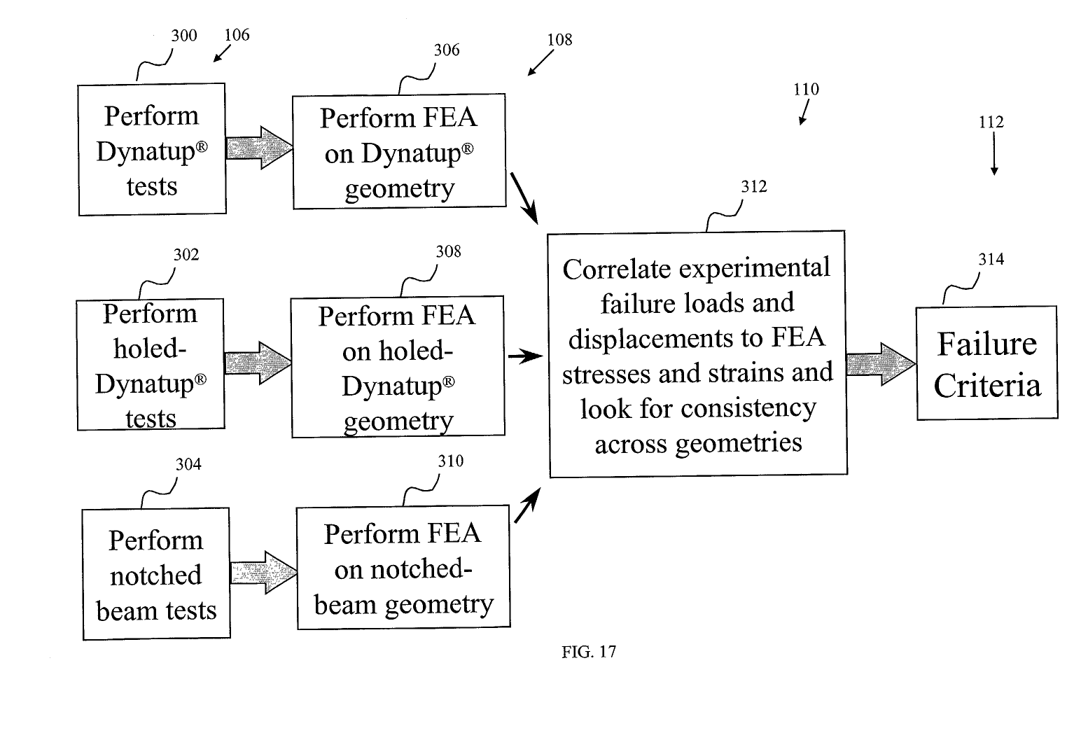

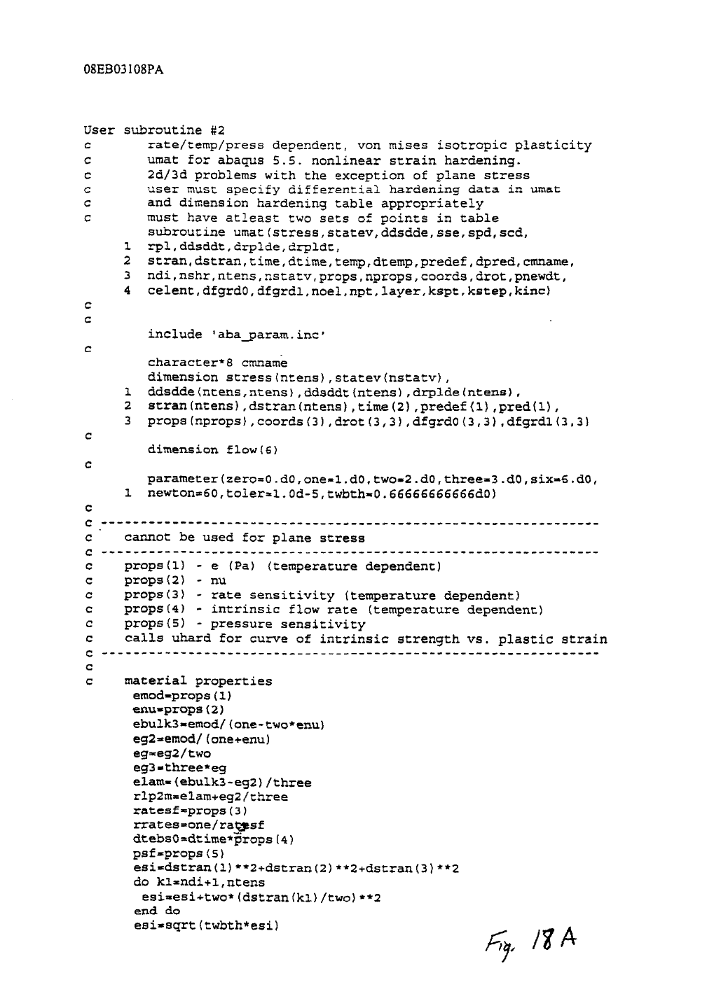

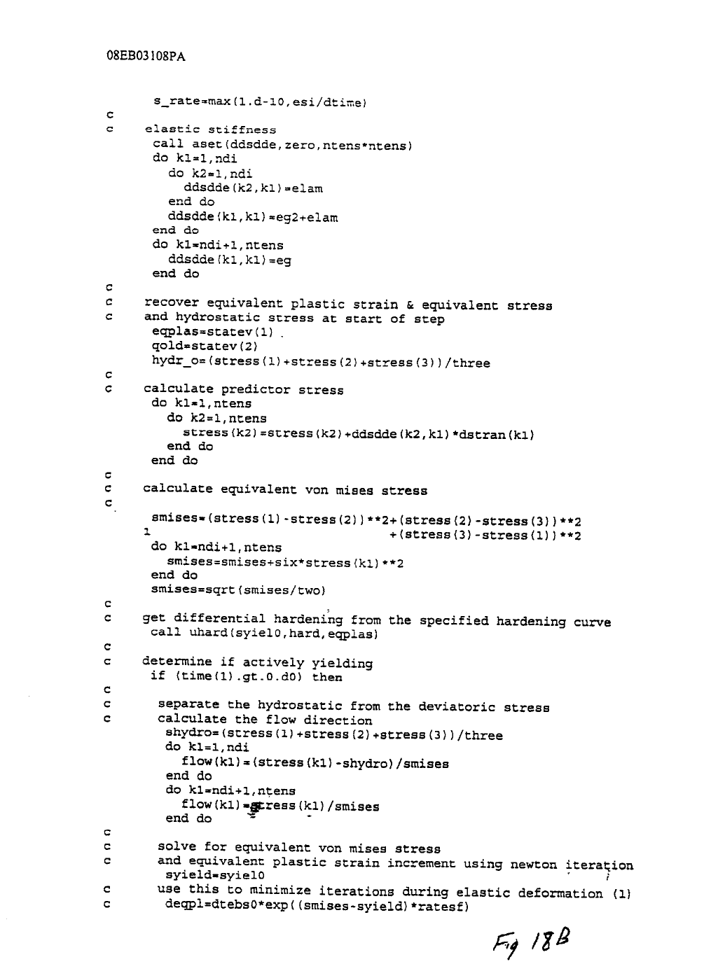

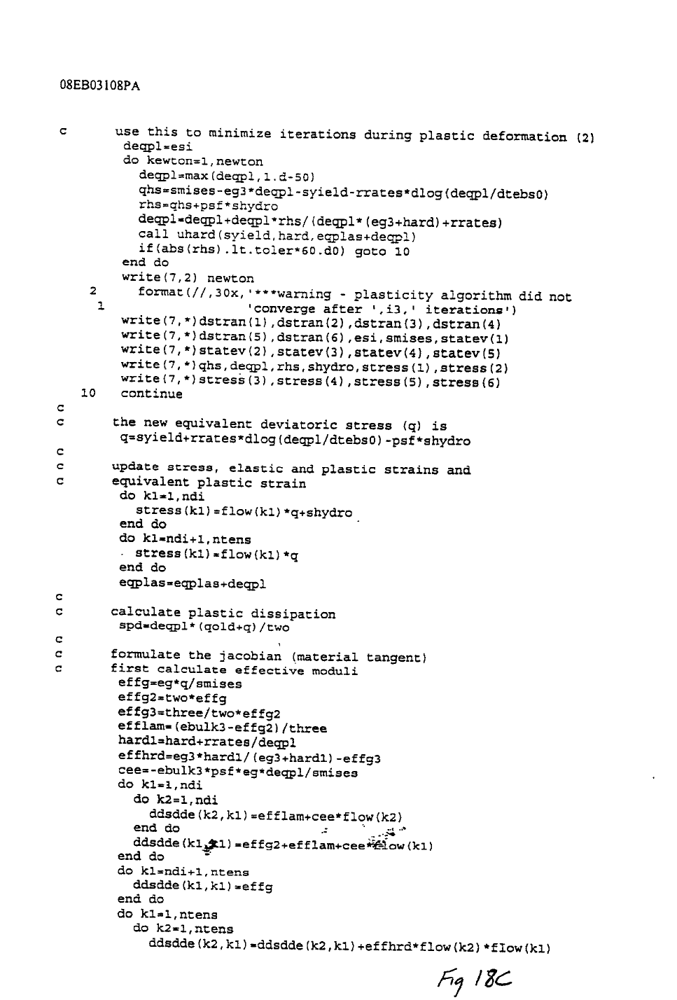

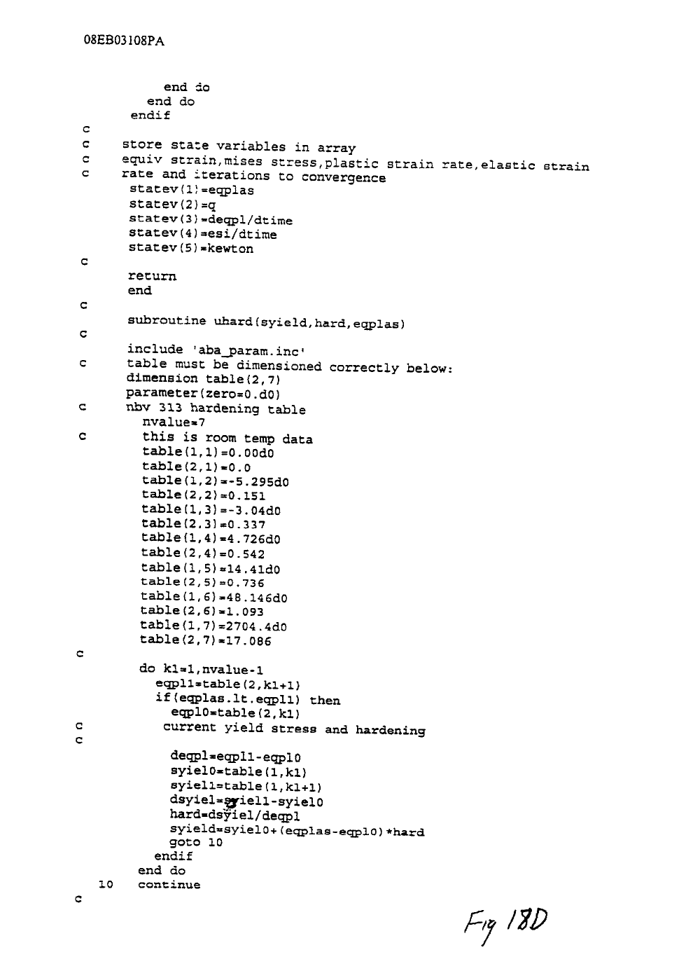

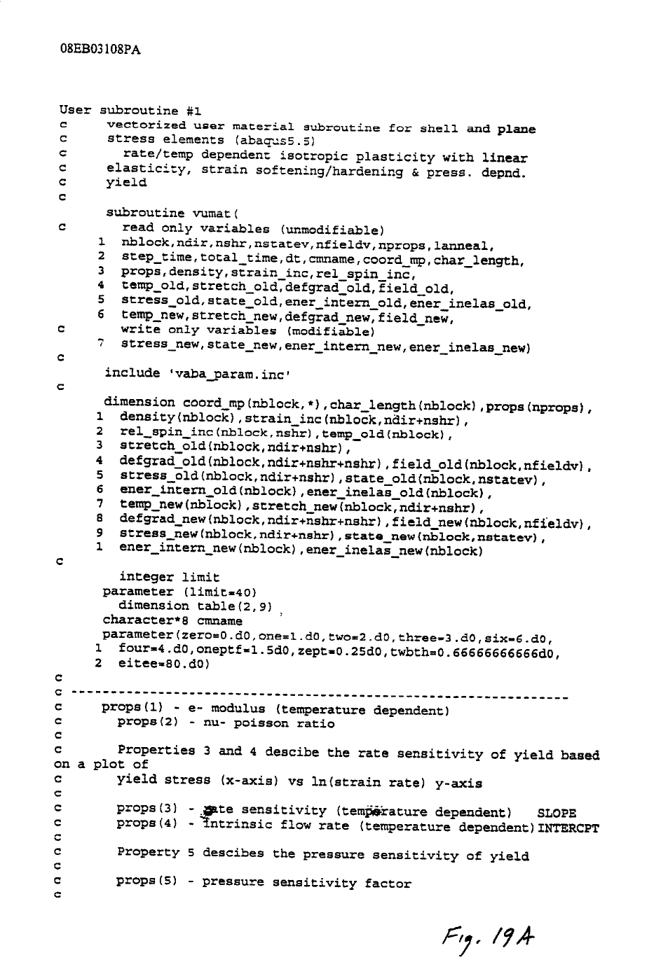

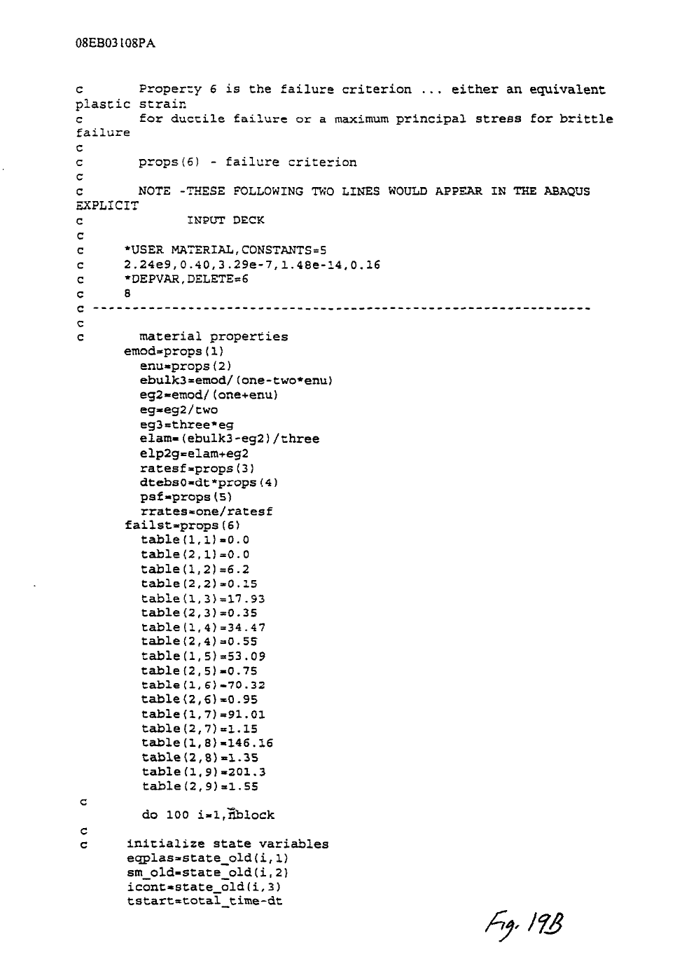

Referring to FIG. 17, steps 106-112 of method 100 (FIG. 2) will now be described in further detail. In steps 300, 302 and 304, to determine possible failure modes for a material and the appropriate values of the corresponding failure criteria, tests may be performed on three different test geometries: a disk, a disk with a hole and a notched-beam geometry (see FIG. 7). For the disk impact tests, standard disks as used in a Dynatup® test (e.g., about 10.16 centimeters (4 inches) in diameter and about 0.3175 centimeter (0.125 inch) thick), may be tested in a servohydraulic machine at constant displacement rates. Disk specimens may be clamped in a rigid fixture with a clamping diameter of about 7.62-centimeter (3-inch) and impacted by a metal, hemispherical impact head with a diameter of about 1.27 centimeters (0.5 inch). These tests produce biaxial stress states. To generate triaxial stress states, notched-beam specimens may be tested in a three-point-bend configuration with the notch in tension (see FIG. 8). Flame bars are convenient to use for such testing and are typically about 12.7 centimeters (5 inches) long, 1.27 centimeters (0.5 inch) high and 0.3175 centimeter (0.125 inch) thick. Thicker flame bars may be molded and are more likely to produce a brittle failure due to a higher degree of plane strain constraint. A standard Izod notch having a depth of about 0.254 centimeter (0.1 inch), an included angle of about 45 degree, and a radius of about 0.254 centimeter (0.01 inch) may be machined into the beam with a cutting wheel. Different radii wheels may be used with brittle failure more likely for sharper radii. Note that 5.08-10.16 centimeter (2-4 inch) spans may have strain rates varying from about 20 1/s to 60 1/s for a 10 millimeter (.3937 inch) radius notch and a displacement rate of 20 inches per second. In steps 306, 308 and 310, strain rates for each geometry are calculated by performing finite element analyses. If different configurations are used, finite element analyses may be performed on the actual specimen and test configuration to determine exact strain rates for given displacement rates. Note that finite element analysis may be more accurate than manual calculations performed to estimate strain rates using a reference having stress concentration factors.

For each geometry, tests may be performed at the temperature of interest (application temperatures) over a range of strain rates. A small range of strain rates may be chosen which brackets the strain rates expected to be seen in a specific part or application, or a large range of strain rates may be chosen, covering a few orders of magnitude, to more fully characterize a material. To estimate a strain rate that a part may be experience, the impact velocity or displacement rate is determined. The impact velocity of interest may be predefined as in a regulatory, agency, or manufacturer required part test, or may be calculated from boundary conditions as specified. A common impact test is a drop test. In a drop test, a part is dropped from a known height or, alternatively, an object at a known height is dropped onto a part. The velocity at impact is calculated by equating the initial potential energy prior to the drop to the kinetic energy just before impact. The impact velocity may be calculated using equation (13) shown below:

v=\sqrt{2gh} (13)

where:

v is the impact velocity

g is the gravitational constant

h is the drop height

The strain rate may then be approximated by using closed form solutions, or by performing finite element analyses. Note that if a part already exists, the strain may be determined by instrumenting the part with strain gages, or by using other strain measuring techniques on the actual part. However, such techniques requiring an actual part are time consuming and costly. For more complex geometries and loadings, or for more accurate results, an initial, elastic, finite element analysis may be used to estimate the application strain rate. Since the application temperatures are generally known, tests may be performed at those temperatures. Note that if the application temperature is not known, a test may be performed, preferably, at the coldest temperature that the part is expected to experience. Additionally, a test may be performed at room temperature. The test specimens may be tested in an environmental chamber and allowed to equilibrate at application temperature for at least one hour prior to testing. For each test performed, load-displacement data may be recorded, including the displacement at break. The displacement at break may be recorded for each test to determine stress and strain levels at failure. The failure mode of the specimen, ductile or brittle, may be recorded as well.

Ductile failures are characterized by a tearing type event typically characterized by a local strain-to-failure. Since tearing failures are localized, test procedures to determine the true local strain at failure are difficult to define. To overcome this measurement difficulty, strain-to-failure values may be determined by correlating mechanical test results to detailed finite element analyses of the simple test geometries described previously. An equivalent plastic strain-to-failure is widely accepted as a ductile failure criterion in the art, and may be used in commercially available finite element packages.

In steps 306, 308, and 310, finite element analyses are performed on each test geometry that failed ductilely using the constitutive model described earlier. Tensile and compression data may be used to calculate the parameters for the constitutive model. The finite element model is validated by comparing the analytical load-displacement response of each geometry to the experimental load-displacement results. For example, FIG. 9 is a plot comparing the analytical load-displacement response to the experimental load-displacement results for an exemplary disk impact. In the example of FIG. 9, five tests were performed. Note that for each strain rate and temperature of interest, about five to ten replicate specimens are preferred (to account for variation). If a specimen starts to transition from a ductile-to-brittle mode, or if a specimen fails brittlely, then about ten to twenty tests are preferred (to account for the higher variability often seen in brittle failures). Next, equivalent plastic strain-to-failure values (e.g., peak equivalent plastic strain levels corresponding to the experimental failure displacements) may be obtained from the finite element predictions. For example, in FIG. 10, equivalent plastic strain-to-failure values are plotted as a function of strain rate for each geometry in the exemplary disk impact.

In step 312, the consistency of the equivalent plastic strain-to-failure value is checked across geometries. Note that for a failure criterion to be valid, it should not be geometry dependent. For example, the equivalent plastic strain-to-failure value predicted in each geometry should be the same or nearly the same. Preferably, values within about 20% of each other may be acceptable to predict part performance. Of course, a different level of consistency may be chosen. For example, conservatively, lower values may be chosen, and/or standard deviations may be calculated (probabilities of failure may be calculated given variation in failure criteria and/or part operating conditions).

In step 314, if failure strain values are consistent, then valid failure criteria has been obtained, and a final plot of failure strain versus strain rate may be created using either average values or lower bounds (see FIG. 11). Note that average values may be preferred for validation purposes, while lower bounds may be preferred for design purposes. If a statistically significant number of samples have been tested, then the failure strain may be treated statistically, thereby, establishing means and standard deviations. Preferably, from about ten to about twenty specimens may be tested for each set of test conditions. Fewer specimens, for example, about five, may be tested if the scatter in the failure displacement is considered low. Note that the exact number of specimens may be left to the judgment of the designer, and/or any guidelines in use and/or any statistical analysis methods that may be employed. Furthermore, statistical tools may be employed to determine the size of the sample set. Again, equivalent plastic strain-to-failure values are obtained as a function of strain rate and temperature, which can later be used to predict ductile failure in impact events.

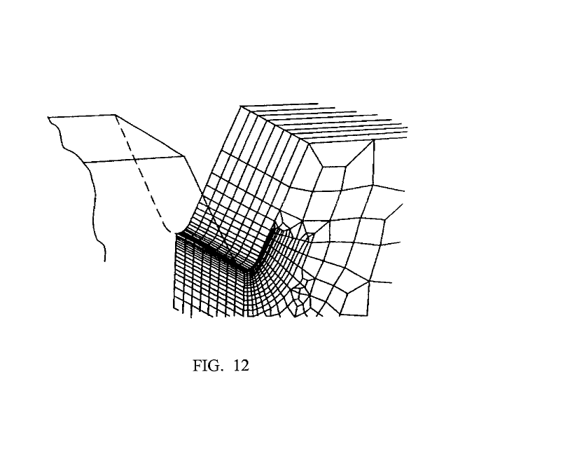

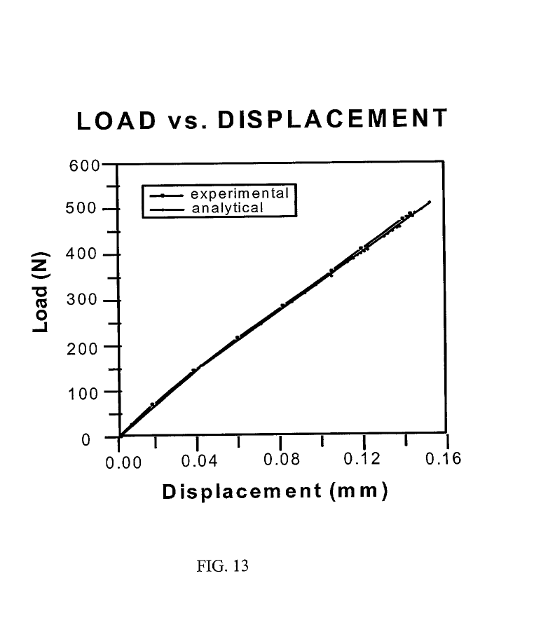

Brittle failures are characterized by a fast fracture usually resulting in specimens or parts that are broken into a few pieces, or many separate pieces. A brittle failure criterion, in the form of a rate dependent, critical, maximum principal stress criterion is used. For example, brittle failure occurs when the maximum principal stress in the part reaches a critical, rate-dependent, value. If maximum principal stress levels within the part are kept below these critical values, then brittle failure is not a concern. In steps 306, 308 and 310, to determine critical maximum principal stress levels that may initiate brittle failure, finite element analyses may be performed on each test geometry that failed brittley (using the deformation model described previously). Note that for the notched-beam test geometry, large stress gradients may be present beneath the notch surface, thus, mesh refinement may be critical in the notch surface area. Preferably, a mesh with sixteen first order elements, spread over a 2 millimeter depth, may be used (see FIG. 12). In the example of FIG. 12, a three dimensional (“3D”) finite element mesh in a three-point-bend notched beam analysis is shown. The finite element model may be validated by comparing the analytical load-displacement response of each geometry to the experimental load-displacement results. For example, FIG. 13 is a plot comparing the analytical load-displacement response to the experimental load displacement results for a three-point-bend notched beam. In the example of FIG. 13, five tests were performed. Preferably, about five to ten tests may be performed (to account for variation). If a significant amount of scatter is seen in the results then ten to twenty tests are preferred. Again, note that the exact number of specimens may be left to the judgment of the designer, and/or any guidelines in use and/or any statistical analysis methods that may be employed.

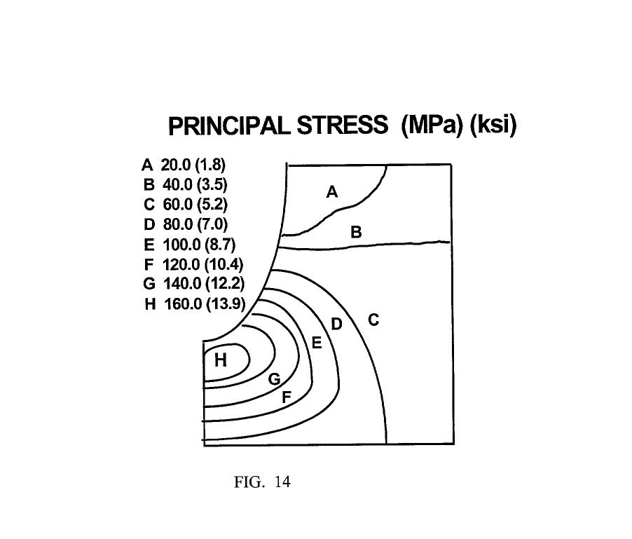

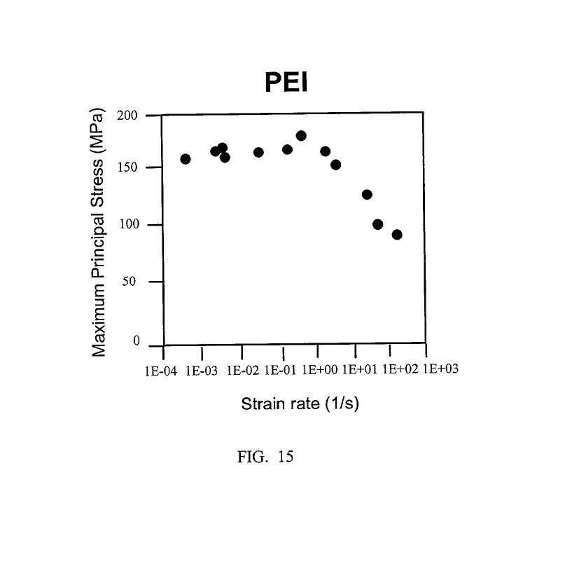

Next, peak maximum principal stress values corresponding to the experimental failure displacements may be obtained from the finite element predictions. In the example of FIG. 14, peak maximum principal stress levels are found beneath the notch surface once plasticity initiates at the notch surface. Very large values (e.g., about 1.4 to 2.3 times the yield stress) of hydrostatic stress and maximum principal stress develop subsurface at the boundary of the elastic-plastic zone (due to the high degree of plastic constraint in this area). If multiple notched beam geometries are tested, maximum principal stress levels at failure may be plotted as a function of strain rate for each notched beam geometry.

In step 312, the consistency of the maximum principal stress at failure is checked across geometries. Note that the maximum principal stress at failure predicted in each notched beam geometry should be the same or nearly the same. Preferably, values within about 15% of each other may be acceptable to predict part performance. Of course, a different level of consistency may be chosen. For example, conservatively, lower values may be chosen, and/or standard deviations may be calculated (probabilities of failure may be calculated given variation in failure criteria and/or part operating conditions).

In step 314, if maximum principal stress values are consistent, then valid failure criteria has been obtained, and a final plot of maximum principal stress versus strain rate may be created using either average values or lower bounds as previously described (see FIG. 15). Critical maximum principal stresses are obtained as a function of strain rate and temperature, which can later be used to predict brittle failure in impact events.

IV. Use of Deformation Model and Failure Criteria in Finite Element Analyses to Predict Part Failure

Failure criteria, both ductile and brittle, may be compared to equivalent plastic strain and maximum principal stress levels from finite element analyses of the part, manually, by looking at result text listings or by looking at contour plots. If these levels are above the failure criteria values obtained, then failure may be predicted. Preferably, the user defined subroutine of FIGS. 18A-D (which includes the deformation model and failure criteria for the material described earlier) is used with a commercially available finite element analysis package to automatically compare equivalent plastic strain levels and maximum principal stress levels versus ductile and brittle failure criteria (which have been predetermined by the method described previously). If either failure criteria is exceeded, the user subroutine automatically sets the element stiffness matrix to zero (wherever the criteria is locally exceeded), simulating failure at that location. The load carrying capability of the part will decrease as more element stiffness matrices go to zero as a result of the failure criteria being exceeded.

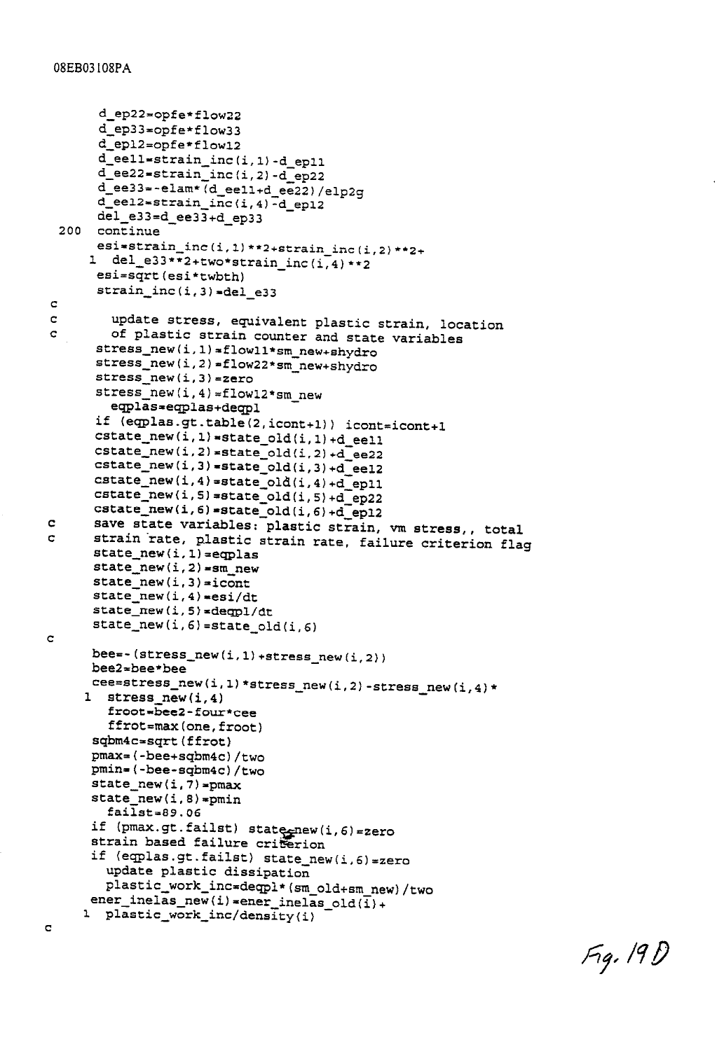

A testing and material modeling methodology has been presented to model the deformation and failure behavior of engineering thermoplastic materials. The deformation of the material is characterized by a 5 material parameter constitutive model along with a table of total stress minus yield stress versus plastic strain. The constants and post yield table are obtained by performing tensile and compression tests. The ductile/brittle behavior of the material is characterized by performing disk, holed disk, and notched beam tests which cover biaxial and triaxial stress states which would be encountered in an actual thermoplastic part. From these tests the failure mode that would be expected can be mapped out. Failure criteria are obtained by performing finite element analyses using the 5 constants and post yield table discussed earlier in a finite element user material subroutine as shown in FIG. 18. An alternative constitutive model for deformation could be used, but the model described above is preferred. By correlating stress and strain levels in these finite element simulations with experimental failure displacements, failure criteria may be obtained. For ductile failures an equivalent plastic strain failure criterion may be used. For brittle failures a maximum principal stress failure criterion may be used. Once the failure criterion have been established, part performance may be predicted through a finite element analysis using a constitutive model that includes the same deformation model used to obtain the failure criterion along with the failure criterion that were established. An explicit finite element user material subroutine using the preferred 5 material parameter and post yield table deformation constitutive model and the ductile and brittle failure criteria is shown in FIG. 19.

The embodiments described herein account for stress state effects upon failure behavior, allow for different failure mechanisms and modes and appropriately assign different failure criteria to different failure mechanisms. Combinations of tests, uniaxial, biaxial and triaxial are used to map out the potential failure modes and to generate data for developing failure criteria. Stresses and strains at failure are accurately determined by performing finite element simulations of the simple test geometries to determine failure criteria (rather than attempting to measure a strain to failure value in a tensile test).

Note that prior art techniques fail to distinguish between failure modes and merely rely on a tensile failure strain to predict failure, thus, not taking into account the effect of different stress states. Further, such prior art techniques rely on uniaxial stress states in tensile specimens to generate failure criteria. Such prior art techniques are deficient because more severe stress states, especially a triaxial stress state, may cause a change in the failure mechanism and, thereby, a change in failure mode from ductile to brittle. In contrast, the embodiments described herein account for the effect of stress state. For example, tensile specimens, disk specimens and notched three-point-bend specimens are all tested representing uniaxial, biaxial and triaxial stress states, respectively. Failure modes are examined for each stress state and failure criteria are generated for each mode by correlating coupon test results with finite element analyses employing the deformation model to determine stresses and strains at failure.

In addition, the embodiments described herein allow for a more accurate determination of ductile failure strains than is currently possible in the simple tensile tests used in current techniques. Tests may be performed on coupon specimens, and failure loads/displacements correlated with finite element analyses using the deformation model to accurately determine true stresses and strains at failure. The consistency of ductile failure strains may also be checked across different stress states, which is not possible when only a tensile test is performed as in current techniques. As mentioned, knowing the potential failure modes of a material, along with having accurate failure criteria for the different failure modes, the impact performance of the part can be more accurately predicted. Further, knowing whether or not a failure will occur, the failure mode, and the load or displacement at failure can be predetermined. Thus, the number of part testing trials and design iterations required to achieve a satisfactory design may be reduced.

The description applying the above embodiments is merely illustrative. As described above, embodiments in the form of computer-implemented processes and apparatuses for practicing those processes may be included. Also included may be embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Also included may be embodiments in the form of computer program code, for example, whether stored in a storage medium, loaded into and/or executed by a computer, or as a data signal transmitted, whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

What is claimed is:

1. A method for predicting impact performance of an article constructed of a material, the method comprising:
applying physical properties of the material to a constitutive model;
performing at least one of uniaxial, biaxial, and triaxial property tests on samples of the material shaped according to test geometries;
performing finite element simulation analysis on the test geometries using the constitutive model;
determining failure criteria of the material using data from said performing at least one of uniaxial, biaxial, and triaxial property tests and said performing finite element simulation analysis on the test geometries; and
applying the failure criteria and the constitutive model to finite element simulation analysis of the article.

2. The method of claim 1, wherein said constitutive model characterizes deformation behavior of the material with respect to strain rate, temperature, and stress behavior.

3. The method of claim l,wherein said uniaxial, biaxial, and triaxial property tests are performed at a practical range of service conditions of the article.

4. The method of claim 1, wherein the failure criteria includes ductile and brittle failure criteria.

5. The method of claim 1, wherein at least two of uniaxial, biaxial, and triaxial test conditions are employed.

6. The method of claim 1, further including:
validating the constitutive model by comparing analytical load-displacement response of each geometry obtained from the finite element simulation analysis of test geometries using the constitutive model with the experimental load-displacement results obtained from said performing at least one of uniaxial, biaxial, and triaxial property tests.

7. The method of claim 1, wherein the constitutive model is represented by the relationship:
$${\dot{\overline{ϵ}}}_{pl} = {\dot{ϵ}}_{0} exp [ A ( T ) \{ σ - S ( {\overline{ϵ}}_{pl} ) \} ] \times exp [ - pα A ( T ) ]$$
wherein:
\overline{ε}ₚₗ is the equivalent plastic strain rate;
\overline{ε}ₚₗ is the equivalent plastic strain;
A, \dot{ε}ₒ are rate dependent yield stress parameters which depend on temperature (T);
σ is the equivalent von Mises stress;
S is internal resistance stress (post yield behavior); and
α is pressure dependent yield stress parameter.

8. The method of claim 1, further including:
determining the physical properties of the material using a tension test and a compression test.

9. The method of claim 8, wherein said determining the physical properties includes:
comparing tensile and compressive yield stresses at the same rate to determine a pressure dependent material parameter; and
inputting said pressure dependent material parameter into the constitutive model.

10. The method of claim 1, wherein determining failure criteria of the material includes:
obtaining peak equivalent plastic strain levels corresponding to the experimental failure displacements, the peak equivalent plastic strain levels being determined from the finite element simulation analysis of the test geometries, and the experimental failure displacements being determined from said performing at least one of uniaxial, biaxial, and triaxial property tests;
plotting the peak equivalent plastic strain levels as a function of strain rate for each geometry;
checking consistency of peak equivalent plastic strain levels across geometries; and
plotting failure strain versus strain rate for each temperature.

11. The method of claim 1, wherein determining failure criteria of the material includes:
obtaining peak maximum principle stress values corresponding to the experimental failure displacements, the peak maximum principle stress values being determined from the finite element simulation analysis of the test geometries, and the experimental failure displacements being determined from said performing at least one of uniaxial, biaxial, and triaxial property tests;
plotting the peak maximum principle stress values as a function of strain rate for each geometry;
checking consistency of peak equivalent plastic strain levels across geometries; and
plotting failure strain versus strain rate for each temperature.

12. A method to predict part impact performance wherein said method comprises incorporating uniaxial stress state, biaxial stress state, and triaxial stress state material characterizations in finite element simulations.

13. A method for predicting impact properties of an article, wherein the method incorporates uniaxial, biaxial, and triaxial property tests determined under a practical range of service conditions in finite element simulations of test geometries to obtain failure criteria.

14. A method for developing failure criteria of a material, wherein the method comprises:
determining physical property characterizations of a material over a range of strain rates;
applying finite element analyses on various geometries; and
correlating failure strains to displacements at a break to obtain failure strain as a function of rate.

15. A method for determining failure criteria wherein the method comprises:
obtaining deformation model parameters;
performing property tests under varying rates and temperatures and recording load displacements;
determining failure displacements for test conditions employed in said performing property tests;
using deformation model parameters in a finite element input deck and post yield data in a user material subroutine;
selecting analysis displacement and time to approximate test failure displacement and displacement rate; and
obtaining equivalent plastic strain for ductile failure and maximum principal stress for brittle failure.

16. A system for predicting impact performance of an article constructed of a material, the system comprising:
a mechanical testing machine configured to perform at least one of uniaxial, biaxial, and triaxial property tests on samples of the material shaped according to test geometries;
an applications server coupled to said mechanical testing machine, said applications server being configured to:
apply physical properties of the material to a constitutive model;
perform finite element simulation analysis on the test geometries using the constitutive model;
receive data from the performance of the at least one of uniaxial, biaxial, and triaxial property tests;
determine failure criteria of the material using the data from the uniaxial, biaxial, and triaxial property tests and the finite element simulation analysis on the test geometries; and
apply the failure criteria and the constitutive model to finite element simulation analysis of the article.

17. The system of claim 16, wherein said constitutive model characterizes deformation behavior of the material with respect to strain rate, temperature, and stress behavior.

18. The system of claim 16, wherein said uniaxial, biaxial, and triaxial property tests are performed at a practical range of service conditions of the article.

19. The system of claim 16, wherein the failure criteria includes ductile and brittle failure criteria.

20. The system of claim 16, wherein at least two of uniaxial, biaxial, and triaxial test conditions are employed.

21. The system of claim 16, wherein said applications server is further configured to:
validate the constitutive model by comparing analytical load-displacement response of each geometry obtained from the finite element simulation analysis of test geometries with experimental load-displacement results obtained from the uniaxial, biaxial, and triaxial property tests.

22. The system of claim 16, wherein the constitutive model is represented by the relationship:
$${\dot{\overline{ϵ}}}_{pl} = {\dot{ϵ}}_{0} exp [ A ( T ) \{ σ - S ( {\overline{ϵ}}_{pl} ) \} ] \times exp [ - pα A ( T ) ]$$
wherein:
\overline{ε}ₚₗ is the equivalent plastic strain rate;
\overline{ε}ₚₗ is the equivalent plastic strain;
A, \dot{ε}ₒ are rate dependent yield stress parameters which depend on temperature (T);
σ is the equivalent von Mises stress;
S is internal resistance stress (post yield behavior); and
α is pressure dependent yield stress parameter.

23. The system of claim 22, wherein said mechanical testing machine performs a tension test and a compression test on the material, and said application server determines the physical properties of the material using data from the tension and compression tests.

24. The system of claim 22, wherein said mechanical testing machine compares tensile and compressive yield stresses at the same rate to determine a pressure dependent material parameter; and inputs said pressure dependent material parameter into the constitutive model.

25. A storage medium encoded with machine-readable computer program code for predicting impact performance of an article constructed of a material, the storage medium including instructions for causing a computer to implement a method comprising:
applying physical properties of the material to a constitutive model;
performing at least one of uniaxial, biaxial, and triaxial property tests on samples of the material shaped according to test geometries;
performing finite element simulation analysis on the test geometries using the constitutive model;
determining failure criteria of the material using data from said performing at least one of uniaxial, biaxial, and triaxial property tests and said performing finite element simulation analysis on the test geometries; and
applying the failure criteria and the constitutive model to finite element simulation analysis of the article.

26. The storage medium of claim 25, wherein said constitutive model characterizes deformation behavior of the material with respect to strain rate, temperature, and stress behavior.

27. The storage medium of claim 25,wherein said uniaxial, biaxial, and triaxial property tests are performed at a practical range of service conditions of the article.

28. The storage medium of claim 25, wherein the failure criteria includes ductile and brittle failure criteria.

29. The storage medium of claim 25, wherein at least two of uniaxial, biaxial, and triaxial test conditions are employed.

30. The storage medium of claim 25, further including instructions for causing a computer to implement:
validating the constitutive model by comparing analytical load-displacement response of each geometry obtained from the finite element simulation analysis of test geometries using the constitutive model with the experimental load-displacement results obtained from said performing at least one of uniaxial, biaxial, and triaxial property tests.

31. The storage medium of claim 25, wherein the constitutive model is represented by the relationship:
$${\dot{\overline{ϵ}}}_{pl} = {\dot{ϵ}}_{0} exp [ A ( T ) \{ σ - S ( {\overline{ϵ}}_{pl} ) \} ] \times exp [ - pα A ( T ) ]$$
wherein:
\overline{ε}ₚₗ is the equivalent plastic strain rate;
\overline{ε}ₚₗ is the equivalent plastic strain;
A, \dot{ε}ₒ are rate dependent yield stress parameters which depend on temperature (T);
σ is the equivalent von Mises stress;
S is internal resistance stress (post yield behavior); and
α is pressure dependent yield stress parameter.

32. The storage medium of claim 25, further including instructions for causing a computer to implement:
determining the physical properties of the material using a tension test and a compression test.

33. The storage medium of claim 32, wherein said determining the physical properties includes:
comparing tensile and compressive yield stresses at the same rate to determine a pressure dependent material parameter; and
inputting said pressure dependent material parameter into the constitutive model.
